(19) United States
(12) Patent Application Publication
(10) Pub. No.: US 2003/0050976 A1
(43) Pub. Date: Mar. 13, 2003

(54) Structure for accessing and populating community websites

(75) Inventors: David A. Block, Sudbury, MA (US); Daniel L. Ahlberg, Pleasanton, CA (US); John Feldmeier, Palo Alto, CA (US); Elliot M. Katzman, North Andover, MA (US)

Correspondence Address: Matthew A.Newboles, STETINA BRUNDA GARRED & BRUCKER, Suite 250, 75 Enterprise, Aliso Viejo, CA, 92656, US

(73) Assignee: Myteam.com, Woburn, MA

(21) Appl. No.: 10/251,174

(22) Filed: Sep. 20, 2002

Related U.S. Application Data
(63) Continuation of application No. 09/546,000, filed on Apr. 10, 2000.
(60) Provisional application No. 60/172,983, filed on Dec. 10, 1999.

(51) Int. Cl. G06F 15/16

(52) U.S. Cl. 709/203; 709/229

(57) ABSTRACT

A website structure for populating the registration database of a website, and for providing access to information contained within various community areas that comprise the website. A plurality of community areas are provided via website pages which contain information pertaining to a community interest. Each registered user will have a home page with personal information. Other overlying community areas might provide group information to which a user belongs, or organizational information to which a group belongs, and so forth. The information within the community areas can be viewed and shared by various users of the website, with access to the information controlled by the status of the user. The membership database for the website is built via invitations from member users to non-member users. An identification can be assigned to each relationship. Access to various information within the community areas is thereby controlled by the status of the user, or the relationship the user has with other member users. The database can thereby be populated by known or trusted persons of current members.

### RELATED APPLICATIONS

This application claims priority under 35 USC 119(e), to the Provisional application entitled “Structure and Method For Accessing and Populating Community Websites,” which was filed on Dec. 10, 1999, and assigned application No. 60/172,983 (Attorney Docket No. MYTEP001P), and which is hereby incorporated by reference.

This application is related to: U.S. patent application Ser. No. ______ (Attorney Docket No. MYTEP002), entitled “Methods For Accessing and Populating Community Websites,” and U.S. Provisional patent application No.______ (Attorney Docket No. MYTEP004P), entitled “Tools and Functionality For Community Website Structures and Methods Thereof,” all filed on the same date herewith, and which are hereby incorporated by reference.

### FIELD OF THE INVENTION

The present invention relates generally to a network system, or website structure thereon, used for the provision of access by an individual to information that relates to multiple website communities in which the individual is a participant. More specifically, the present invention provides website structures for summarizing access to the information pertaining to an individual's involvement in these multiple communities. The extent of access to the website information for a specific community is based upon the security level of the individual in relation to the community, and which is granted to them by other members of that community.

### BACKGROUND OF THE INVENTION

Computer networks provide an efficient means for transporting data between workstations or terminals on (or connected to) the network. Such networks can consist of Local Area Networks (LANs), which are generally restricted to one geographical area or location. Such networks can also include Wide Area Networks (WANs) which connect a number of machines over a larger geographic area. The Internet is also an example of one such network. The Internet is a worldwide system of computer networks—or a network of networks—wherein users at any one computer can, if they have permission, get information from any other computer. The Internet was conceived by the Advanced Research Projects Agency (ARPA) of the U.S. government in 1969 and was first known as the ARPANet. The original aim was to create a network that would allow users of a research computer at one university to be able to “talk to” research computers at other universities. A side benefit of the ARPANet design provided that messages can be routed or rerouted in more than one direction, and that the network can continue to function even if parts of it were destroyed in the event of a military attack or other disaster (including simple down-time of component parts).

Today, the Internet is a public, cooperative, and self-sustaining facility accessible to hundreds of millions of people worldwide. The Internet is providing ever increasing opportunities for persons across the world to interact with each other via a relatively cheap medium of communication. A person might use a computer to pull up a website and see information that might pertain to an organization to which that person belongs, or is affiliated. Many such websites require a registration procedure to be completed, wherein the user provides certain personalized information and is assigned an identifier to use when accessing the site. Through this identifier, the user can access personal, or private information from a database or the like associated with the website. The personalized identifier generally prevents such information from being accessed by other users of the website.

Many Internet sites also have community aspects associated with them.

Community aspects provide the ability for a member to interact with a variety of other members on the site who share a commonality. For instance, the user might post and/or retrieve information from a website, or certain areas of a website. Depending upon the nature of the information being posted or retrieved, security issues become important in discerning who will be allowed to become a member of any given community and thereby retrieve and/or post specific information.

In present Internet sites, an impetus is placed on personalization of an individual's experience on a website by providing them easy access to only the information that is relevant to the interests that they have identified. The information then provided is a subset of the significant amount of information that is available on the website. Such tailoring of information to the individual can provide incentive for people to join a website, and thereby increase the size of the registration databases as quickly as possible. Larger registration databases and the ability to target messages to groups of members with definable demographics provides the ability for websites to charge higher advertising rates. Additionally, larger registration databases generally lead to a higher relative valuation for the website company. Internet sites with registration systems are generally populated by various users coming to the site for the content and communities contained therein. Typically, a certain amount of content and limited access, if any, to communities is provided to casual visitors to the site. Increased access to content and communities is offered thereafter upon completion of the registration process. Membership in more than one website community requires that the individual have a separate membership identifier and password for each community they are part of. This results in the need for the individual to log-in separately to each website community in order to access the information contained therein. The information in each website must be manually reviewed and consolidated in order to get a comprehensive summary of all of the activities and responsibilities the individual has in their different communities.

The combination of privacy concerns about undesired use of user registration information, and security concerns about access to information in a user community often makes it difficult to expand a registration database. In such situations where registration is required, many users are dissuaded from joining because of the requirement to provide certain personal information. Such users believe that their privacy is being violated, as many websites will thereafter forward (or sell, or datamine) a user's information, for marketing purposes and the like. This is particularly true where the community information involves children, or other family members, or a particular user. To overcome the concerns of privacy and security, a website must provide a significant benefit to the member in exchange for the risks that are perceived. Such opportunities often occur with website communities involving sporting events, school events, or the like. For instance, an individual may be a participant in multiple sport teams, events or organizations, each having a separate schedule of events. Such information in a website might include scheduled events and games and specifics on their locations, news about teams and events, and so forth. A parent or guardian may likewise have several children, each of whom participate in multiple teams, events or organizations, yet are dependent on their parents for transportation and other means of involvement. The management and consolidation of information across multiple community websites for several family members can be very tedious and subject to error.

Accordingly, what is needed in the field is a method and apparatus that allows a user to have a more efficient means access to all of the website information that is relevant to their participation in multiple communities (games, organizations, and events). This should also include access to the different communities that their children may also participate in. This should include a means by which access to the information contained within multiple communities can be accomplished through a single member identifier and password. A structured level of access to various community information should be provided, wherein a user's access to information is based upon a security access level granted by other members of that community. This could result in an individual's access to different communities to vary, even though a single member identifier and password is used to access them.

### SUMMARY OF THE INVENTION

To achieve the foregoing, and in accordance with the purpose of the present invention, certain information structures are provided for forming information structures which will allow for more secure development of the information structure, and for more secure and user-flexible methods of providing access to post/retrieve information in the structure. The most common example of such an information structure includes a website, as comprised of webpages. For discussion purposes, the present invention will be described in terms of a website structure, with the present invention not being limited to this example structure.

A community of inter-related users is created through the website structure, with the community growing through members of the site selectively adding individuals to the community and sending out invitations for them to join the website and the specific community. These invitations are sent to known and trusted individuals who are either not yet members of the website or who are members of the website but not yet a part of the specific community. The invitees who are not yet a member of the website can thereafter choose to register with the website, and become a part of the Community. Existing members of the website can accept their invitation into their current website membership. The subsequent access to other communities that are part of the greater website, and those to which the existing website member is invited will be facilitated through the initial member identifier and password.

Communities relating to the Internet generally provide a method of sharing information between a large number of persons who might be interested in one topic. Such communities might include sports teams, school activities, clubs, or the like.

Information within such a community might include personal schedules, pictures, or other items having a personal nature. In certain instances, it will be desirable to share such personal information with other members of the community. The level of sharing will often depend upon the role (or status) of the person associated with the particular community.

The present invention is described in terms of a sports-oriented website, namely myteam.com and its owned websites (www.dixie.org, etc). This site includes a multitude of web pages, some of which are restricted to viewing only by Members and their selected invitees. A given page may be viewable in two or more versions, with elements on the page appearing or being hidden from view depending on the access level that the individual has in relation to the page. Many of the elements on the page are contained within capsules that show a summary of the information that is displayed on the page that is linked to the capsule.

Three (3) types of Communities are described, and access to the list of each Community's members is available only to the owner (or administrator) of the Home pages which are associated with each Community. A first type of Community includes a Members own Home page, and contains personalized material pertaining to that Member and summary information from the community websites in which the Member is an invited participant. A second type of Community includes a Team Home page, and contains Team information. A third type of Community includes a League Home page, and contains League information. These particular Communities are presented by way of example, and the present invention is not intended to be limited to these three example Communities. The same functionality has wide applicability to families, schools, community groups, scouting organizations and the like. A school implementation could, but is not necessarily restricted to, be organized around a specific school, which may or may not have a shared affiliation with other schools, and also around its classes and the students. An implementation for a family could, but is not necessarily restricted to, be organized around an extended family or a family-oriented organization, such as a church or community group, and also around a family, extended or immediate, and the individual members of that family. A implementation for a community group could, but is not necessarily restricted to, be organized around a specific organization or church which sponsors it, and which may have shared affiliation with other groups and organizations, and also around the group itself and the individual members of the group. An implementation for scouting could, but is not necessarily restricted to, be organized around a specific regional scouting group, which may or may not have an affiliation with a larger organization, and also round a troop, its sponsor, and the individuals of the troop. The spirit and scope of the present invention includes, among other things, the inter-related nature of the communities, along with selectable access being provided based upon the status of any particular user of the website.

By expanding the registration base of the website, and/or access to personal information through invitations to trusted persons, a website can be expanded in a relatively secure manner. Persons joining the community will be a friend or trusted person of at least one other person in that community. Even with this structure, an undesirable person might enter a community (or be invited to enter) through an ill-advised invitation. As a result, the Administrator at any particular level will ultimately have overriding power in determining who will be allowed to join a Community, or who will be removed from having trusted access to a Community. An individual can be listed as a member of a Community without being granted trusted access to information on the website. This enables a Community on the website, that also has a non-website presence, to represent its total membership, not all of whom may have joined the Community on the website.

Within the interacting (and overlying) structures of the various Communities—i.e. League/Team/Personal (or My) Community structure—persons can have access to different information based upon the particular access level assigned to that person in relation to a specific community. The person can request a change of access from the administrator in order to be allowed to see more information on one or many of the various sites. If deemed appropriate, the administrator will then invoke that particular change of status in the myteam.com system.

When an individual is added to the community listing and subsequently invited, they are given a pre-defined level of access to that community and any directly-related community (i.e., when invited to a team, access is also granted to the league within which the team plays). Each member of the Community will have a different access level based upon their role or status in the website structure. Some members have access to edit/change/post information while others only have access to view the information. The level of access granted is pre-defined by the access level of the current community member who invited them and the role in the community to which they have been added.

As an example, when a parent is added to the information for a child, they are automatically granted access to the child's home page and to any team or league that the child is a participant in. When an individual is unassigned to a team or is assigned to a team, the access of their parents, and non-parental contacts are changed to match the relationship of the child to those communities. An individual cannot invite someone to have an access level higher than they themselves have. An individual's access to a community is enabled once they have accepted the invitation. An administrator for the community can alter the level of access granted to the individual, either before or after an individual accepts the invitation.

An Administrator will monitor membership of such community members and can completely remove, or just deny trusted access, to any member whose conduct on the website does not fit the desired standards of the community. To facilitate website communities that are components of organizations that also have a non-website presence, individuals can be added to a community's listing without being invited to join the community as a member on the website. This can include (for example) members who once had trusted access to the community, but subsequently had it removed by a community administrator.

The website structure provides for multiple communities to be present, some of which may have a relationship to each other. For example one community may be a subset of a larger community, and membership in the subset community may include membership in the larger community. Additionally, a given member may themselves be a member of multiple communities, and may have responsibility for family members who themselves are members of communities.

The information that is posted and viewable on one community's pages may also automatically be made available to view on another community's pages, when the communities have a superset/subset relationship. For example a game scheduled by the league will appear on the schedule for the teams that are playing in the game. Likewise, the score of a game entered by a team will appear on the scoreboard for the league that the team is in. If a team administrator enters a player into the team roster, the player will also appear on the league's roster.

Each individual who registers with the website gets a personal home page. This age is the first page viewed when the member provides their unique member identifier and a password. This page provides links to the different communities that the individual is part of, including teams, leagues, and the home pages of other individuals who have been granted trusted access to this individual's home page. The individual also has the ability to remove oneself from having trusted access to a community, unless they are the only “owner” or administrator for that community.

The personal home page, and the pages linked behind it, display summaries of the information to which the individual has access, in the communities of which they are a member. This includes schedule information for communities that an individual's children are members of. All schedule information from all of their communities is displayed together on a personal schedule page, with the most current upcoming events being displayed on a schedule capsule on the personal home page. All messages from all of their communities are displayed together on a personal messages page. When clicking on a specific message or schedule item, the ability for the individual to see or edit the detail on that item is the same as would be possible by accessing the information through the home page for the respective community.

The personal home page provides convenient access to many different communities in one viewing location. As such a parent with children can use the home page for convenient access to all of the communities in which the children of the parent might participate. One example of such convenience would be to therefore observe all practice and/or game schedules for all children in one viewable location. Such schedules might be uploaded or downloaded to other devices, such as PDAs or the like.

The communities within the framework of the present invention readily provide for flow of information from one community to another. Relatedly, information flows from a community in which the individual is a participant onto their personal home page.

Additionally, the website might employ a device (software, hardwire, or a like device) to provide for auto-generation of an access level for an invited person based upon the role that the person retained when they were added to the website (as a registrant).

Whereas a registered member usually sends out invitations based upon a trusted relationship they might have with another person, a messaging center associated with the website might automatically send out invitations based upon certain conditions or events.

Further, the website might use shell accounts to hold role and security associations associated with an invited person until that invitation is accepted. When accepted, the shell account is turned into a member account for the invited person, who then becomes a registered member.

According to one aspect of the present invention, an information structure in provided having a plurality of inter-related community areas for sharing information with users, the community areas having levels of information that are selectable accessible, the information structure comprising: a first community area having information personal to a particular user; a second community area having information pertaining to groups to which the particular user belongs; a third community area having information pertaining to organizations overlying the groups; whereby each user accessing the information structure is assigned an individual access level which allows the user to access different levels of information from the plurality of inter-related community areas based upon this access level.

According to still another aspect of the present invention, a website structure is provided for providing access to a plurality of community information areas, the structure comprising: a first community information area having personal information which is administrated and access controlled by a member user; and at least one other community information area having overlying information pertaining to the member user, whereby the overlying information is accessible in part by the member user depending upon an access level associated with the member user.

According to yet another aspect of the present invention, an Internet website structure is provided that facilitates the secure population of the website with users that can access information from a plurality of community areas, the website structure comprising: a central administrator for controlling an access level assigned to website users; a first community area that is administered by a registered user of the website; at least one additional community area that is inter-related to the first community area, whereby the access level assigned to website users of community areas is related to the status of the website user.

According to a further aspect of the present invention, a website structure is provided for facilitating convenient access by a user to multiple sources of community information relating an organizational heirarchy, the structure comprising: a home page having a plurality of window areas for displaying personal and organization information, the home page being created for a user upon registering with the website; a main organization that oversees at least one subordinate group, the group belonging to the main organization, and the user belonging to the at least one subordinate group or other groups subordinate thereto; wherein the window areas are configured to display a selection of user information, group information and/or main organization information, with certain information flowing down from at least the main organization or subordinate groups, the home page thereby providing the convenient access point for the user to view information pertaining to the organizational hierarchy.

According to a further aspect of the present invention, a website structure is provided for providing a convenient access to common interest information relating to an organization having groups to which a user belongs, the structure comprising: a personalized user home page that is created when the user registers with the website; at least one display area on the home page for showing common interest information for the groups to which the user belongs; wherein as the groups provide updates in common interest information, the user can refer only to their home page for such updates by the different groups within the organization.

According to a further aspect of the present invention, a website structure is provided for facilitating convenient access to sport schedules and information pertaining to a user that belongs to at least one team registered with the website, the website structure comprising: a personalized home page that is created for each registered user, the page being configurable to display selectable team information; click-through areas that allow a user to selectably add or remove teams and thereby display that team information on the user's home page; whereby the user can conveniently view schedules and information pertaining to the different added teams via accessing only their one home page.

These and other aspects and advantages of the present invention will become apparent upon reading the following detailed descriptions and studying the various figures of the drawings.

### BRIEF DESCRIPTION OF THE DRAWINGS

The invention, together with further advantages thereof, may best be understood by reference to the following description taken in conjunction with the accompanying drawings in which:

FIG. 1 is block diagram showing a representative site map, according to one aspect of the present invention, of the myteam.com website.

FIG. 2 shows a representative chart, according to one aspect of the present invention, of the various access levels that might be achieved by different types of users, in relation to different Home site elements.

FIG. 2A shows an alternative viewpoint of the website or information structure as generally shown in FIG. 1.

FIG. 2B shows an example viewpoint of the Home Page, as created for each registered website user, interacting with different communities.

FIG. 2C shows an example diagram of a parent/guardian being able to access, via their home page, all communities areas in which their children participate.

FIG. 2D shows an example diagram of the central website and/or database using the role of the invited person to automatically generate an access level.

FIG. 2E shows a similar diagram to FIG. 2D, wherein a shell account is created upon sending of the invitation to an invited person, and the shell account is turned into a member account upon acceptance by the invited person.

FIG. 3 shows certain representative webpage elements, according to one aspect of the present invention, of the My Home page for a player.

FIG. 4 shows certain representative webpage elements, according to one aspect of the present invention, of the Team Home page as viewed by a Team Administrator.

FIG. 5 shows certain representative webpage elements, according to one aspect of the present invention, of the League Home page as viewed by a Member.

FIG. 6 shows certain representative webpage elements, according to one aspect of the present invention, of the Team Home page at the end of Team Find operation.

FIG. 7 shows a flowchart having certain representative elements, according to one aspect of the present invention, of the My Communities site flow map.

FIG. 8 shows a first representative webpage of certain elements, according to one aspect of the present invention, of the My Friends selection from the My Home page.

FIG. 9 shows an alternative representative webpage of certain elements, according to one aspect of the present invention, of the My Friends selection from the My Home page.

FIG. 10 shows a first representative webpage of certain elements, according to one aspect of the present invention, of the My Teams selection from the My Home page.

FIG. 11 shows an alternative representative webpage of certain elements, according to one aspect of the present invention, of the My Teams selection from the My Home page.

FIG. 12 shows a flowchart having certain representative elements, according to one aspect of the present invention, of the Team Communities site flow map.

FIG. 13 shows a first representative webpage of certain elements, according to one aspect of the present invention, of the Team Roster selection from the Team Communities area.

FIG. 14 shows an alternative representative webpage of certain elements, according to one aspect of the present invention, of the Team Roster selection from the Team Communities area.

FIG. 15 shows a first representative webpage of certain elements, according to one aspect of the present invention, of the Team Fans selection from the Team Communities area.

FIG. 16 shows an alternative representative webpage of certain elements, according to one aspect of the present invention, of the Team Fans selection from the Team Communities area.

FIG. 17 shows a representative webpage of certain elements, according to one aspect of the present invention, of the Team Spectators selection from the Team Communities area.

FIG. 18 shows a representative webpage of certain elements, according to one aspect of the present invention, of the League Members selection from the League Communities area.

FIG. 19 shows a representative webpage of certain elements, according to one aspect of the present invention, of the League Fans selection from the League Communities area.

FIG. 20 shows an alternative representative webpage of certain elements, according to one aspect of the present invention, of the League Fans selection from the League Communities area.

FIG. 21 shows a representative webpage of certain elements, according to one aspect of the present invention, of the League Spectators selection from the League Communities area.

FIG. 22 shows a representative webpage of certain elements, according to one aspect of the present invention, of the New Invitations selection from the My Communities area.

FIG. 23 shows an alternative representative webpage of certain elements, according to one aspect of the present invention, of the New Invitations selection.

FIG. 24 shows a representative webpage of certain elements, according to one aspect of the present invention, of the Change User Access selection from the Communities area, which an Administrator might use to change the access, whether or not an individual requested the change.

FIG. 25 shows a representative webpage of certain elements, according to one aspect of the present invention, of a Request for a Change of Access selection from the Communities area, which the Member uses when they want to request a change of access from the administrator.

FIG. 26 shows a representative block diagram, according to one aspect of the present invention, of the hierarchy associated with the League structure, including League Profile, League Teams, and League Members.

FIG. 27 shows a representative block diagram, according to one aspect of the present invention, of a hierarchy associated with the League Profile side bar item.

FIG. 28 shows a webpage having certain representative elements, according to one aspect of the present invention, which are associated with the League Profile selection.

FIG. 29 shows a webpage having certain representative elements, according to one aspect of the present invention, which are associated with the Editing League Profile selection.

FIG. 30 shows a webpage having certain representative elements, according to one aspect of the present invention, which are associated with the Select Contact selection.

FIG. 31 shows a webpage having certain representative elements, according to one aspect of the present invention, which are associated with the League Profile -Divisions selection.

FIG. 32 shows a webpage having certain representative elements, according to one aspect of the present invention, which are associated with the League Divisions -Add/Edit selection.

FIG. 33 shows a webpage having certain representative elements, according to one aspect of the present invention, which are associated with the League Teams selection. FIG. 34 shows a webpage having certain representative elements, according to one aspect of the present invention, which are associated with the League Teams Main Page selection.

FIG. 35 shows a webpage having certain representative elements, according to one aspect of the present invention, which are associated with the League Teams Add/Edit selection.

FIG. 36 shows a webpage having certain representative elements, according to one aspect of the present invention, which are associated with the League Teams—Team Roster page selection.

FIG. 37 shows a representative block diagram, according to one aspect of the present invention, of a hierarchy associated with the League Members side bar item.

FIG. 38 shows a webpage having certain representative elements, according to one aspect of the present invention, which are associated with the League Members—Players page selection.

FIG. 39 shows a webpage having certain representative elements, according to one aspect of the present invention, which are associated with adding Players, Volunteers, or Officers to the League Members.

FIG. 40 shows a webpage having certain representative elements, according to one aspect of the present invention, which are associated with selecting Players and assigning them to teams.

FIG. 41 shows a webpage having certain representative elements, according to one aspect of the present invention, which are associated with selecting available League Volunteers.

FIG. 42 shows a webpage having certain representative elements, according to one aspect of the present invention, which are associated with selecting available League Volunteers for officer positions.

FIG. 43 shows a webpage having certain representative elements, according to one aspect of the present invention, which are associated with displaying a League Member's detailed information.

FIG. 44 shows a webpage having certain representative elements, according to one aspect of the present invention, which are associated with displaying a League Officer's detailed information.

FIG. 45 shows a webpage having certain representative elements, according to one aspect of the present invention, which are associated with editing detailed information pertaining to an individual.

FIGS. 46A and 46B show a generalized computer system architecture that might be used to implement certain aspects of the present invention.

### DETAILED DESCRIPTION OF THE INVENTION

### Section 1—Communities

The present application relates to providing a website (and associated webpages) having a structure which facilitates the secure access, development, and population of the website, and its community features. While the example website described herein is presented in terms of sports-oriented topical material and its related community, the principles described herein are readily applicable to other types of websites employing community aspects. This is particularly true for websites relating to the posting of personal information about a person, the person's family, or the like. Such instances might include school activities, extracurricular activities, clubs, and so forth. Accordingly, the present invention provides controllable levels of access for different visitors to the website, as conditioned upon the visitor's status and access level. The structure provides communities which are formed on an invitational basis, and as such, such selective invitations add a further level of control in populating a community with known persons. Additionally, administrator(s) at each structural level of the website have the ability to override and control access to certain information. Certain administrators can also control who can become a member of an administered community. Information that is posted on one website can be accessed from the website of another related community as well as from the home page of an individual participant in those communities, based on the individual's access to each community.

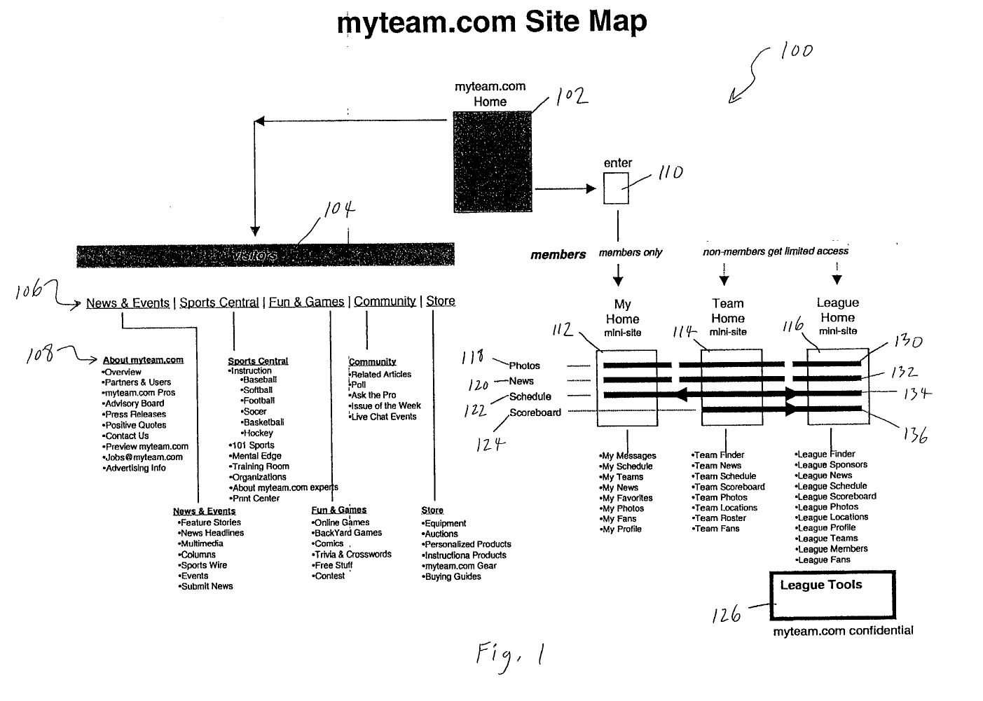

The present invention describes three types of communities. Each community is accessible only by the owner, and their invited guests, of certain respective Home Pages. Referring now to FIG. 1, a block diagram 100 is shown of certain representative elements comprising a site map for the myteam.com website. There are two broad areas to the site. The first area has general content material, which is accessible by visitors to the myteam.com website. The second area is comprised of Home pages, which are generally accessible only by members. To a limited degree, however, a visitor can see some information on these pages.

A representative user model might include the following definitions. The present invention is not intended to be limited to such terms, and such terms are proposed only to facilitate description of the sports-oriented myteam.com website example. A “Member” is an individual who has registered with the myteam.com website, and has been assigned a “Member-ID” (or symbol) and password. The Member uses this Member-ID and associated password when logging onto the system. Each Member is assigned a “My Home” personal page. A “Visitor” is not a myteam.com Member, or is an individual viewing the site without currently being logged in. A Visitor cannot see any My Home personal pages. In order to see such pages, a Visitor must be invited by the individual who “owns” the page through an “Invitation”. Upon accepting the Invitation, the Visitor will become a myteam.com Member in the process. “Administrator” is an individual with “owner” or primary edit control over the web pages for a given community. “Friends” include other Members who must be invited by the individual to see their personal My Home page. “Participants” derive from a private relationship granted by a League or Team Administrator to only those who play on the team, are the parents of those who play on the team, and are those who directly participate in the running of the team and/or its parent league. At the discretion of the Administrator, such a relationship can include reciprocal pre-granted access between the personal My Home pages of the Team Participants.

Regarding specific Team or League Home pages, a “Fan” is a trusted relationship that must be granted or provided through an Invitation by the Administrator of the Team or League. Invited Fans must become a myteam.com Member, if they are not already. Fans include trusted friends and family (who are not parents of players) and do not directly participate in the running of the Team. A “Spectator” is a site Visitor or Member who has not been granted Fan acess to the Home page. The Spectator might also be referred to as an “Anonymous Guest”.

Invitations include an Invitation-Number that must be used to accept the Invitation. For any individual who is added to a community and is not identified as a current website Member by the inclusion of a valid Member-ID, a “Shell Account” is created for that individual. This Shell Account contains the security relationship of that individual in relation to the specific community or communities that they are added to. This Shell Account also includes the general information entered for the individual, such as email address, phone number, etc. When an Invitation is sent to an individual to join, the included, and required, Invitation-Number is directly linked to this Shell Account. Upon accepting the Invitation, the user must complete the registration form, which is pre-populated with the general information that was entered when the individual was added to a community. When the registration form is successfully completed and submitted, the Shell Account is replaced with a “Member Account” which references the Member-ID and which contains the primary information about this website Member and all security access relationships to all communities in which the Member is a Participant.

An individual is sent and accepts an invitation in the following manner. A personal Invitation (with an Invitation-Number) would be sent by paper or email, inviting the recipient to view a My Home, Team Home and/or League Home page. The recipient would take the Invitation-Number and go to the myteam.com registration page, which prompts for the Invitation-Number. The system uses the Invitation-Number to reference the Shell Account that contains the security relationships between the new Member and any My Home, Team Home and/or League Home pages to which they have been invited. The new Member gets their own My Home page, and links on their My Home mini-site pages to the My Home, Team Home and/or League Home pages to which they were invited. When an individual accepts an Invitation to a My Home page, the link to the invitor's My Home page is on their My Fans page. When the individual accepts an Invitation to a Team Home and/or League Home page, the link to the respective Home pages is in their My Teams capsule and on the My Teams page. If the individual invited is already a Member, upon entering their Invitation-Number on the registration page, they will be given access to the respective Home pages using their current Member-ID and single log-in.

Information displayed on Home pages is organized into 3 distinct views—a “Capsule”, a page and a detail page for a specific item of information. A Capsule is shown on a Home page and lists a summary of the most relevant content that is displayed on the page and to which the Capsule itself links. For each item of information there is a linked detail page that shows all of the information for that specific item. For those individuals with Administrator access to the specific information, a “edit” link is displayed that goes to an editable version of the detail information page for that item. Clicking on a specific item of information in the Capsule will go directly to its respective detail information page, and will display the “edit” link if the individual has “write” access. Clicking on the named header of the Capsule, or on the button of the same name in the navigation bar, will go to the general page for that type of information. The specific items of information displayed in a Capsule and on its linked page can come from another Home page mini-site. The ability of an individual to see a specific item of information on a My Home, Team Home or League Home page, capsule or page linked in the mini-site is based on their security access to that type of information on the Home page that it comes from.

Referring again to FIG. 1, the myteam.com home page 102 is shown as the entry point for users entering the website. Visitors 104 can access a variety of general tabbed information 106, or overview information 108. Such overview information 108 is shown to include various information “About myteam.com.” Example topics that are listed include: overview, partners & users, myteam.com Pros, Advisory board, Press Releases, Positive Quotes, Contact information, Preview information, jobs at myteam.com, and advertising information. The tabbed information includes: “News & Events,” “Sports Central,” “Fun & Games,” “Community,” and “Store.” The “News & Events” tab can be used to pull up topics such as: feature stories, news headlines, multimedia, columns, sports wire, events, or news submission. The “Sport Central” tab is shown to include: Instruction about various sports (i.e. drill strategies, game instruction), 101 sports (i.e. descriptions of various sports), mental edge, training room, organizations, information about myteam.com experts, and print center information. The “Fun & Games” tab includes: online games, backyard games, comics, trivia & crosswords, free stuff, and contest information. The “Community” tab includes: related articles, polls (i.e. favorite equipment, etc.), “ask the pro” information, issue of the week, and live chat events. The “Store” tab is shown to include: equipment, auctions, personalized products, instructional products, myteam.com gear, and buying guides, all of which can be acquired as “ecommerce” (i.e. electronic commerce) items. For this set of Visitor information, anybody that comes to the myteam.com site will have access to such information. The viewing experience is generally the same for Members and Visitors.

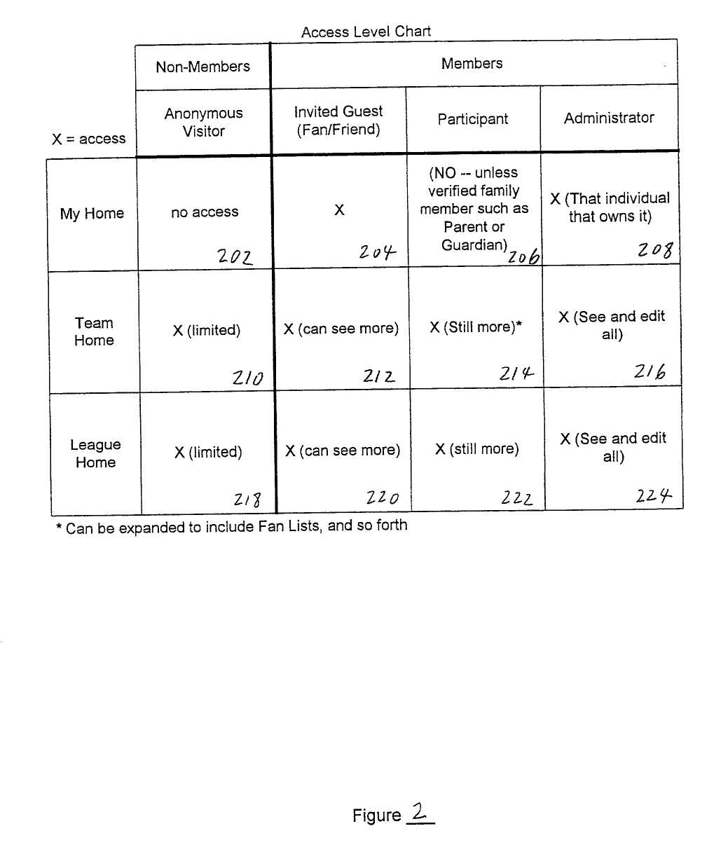

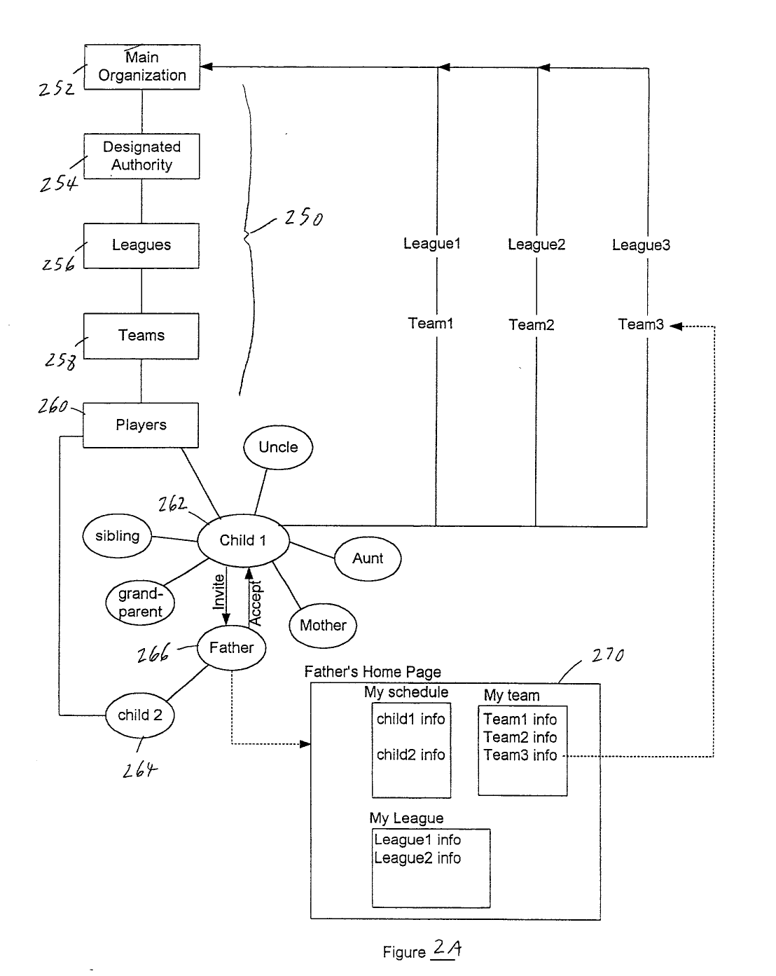

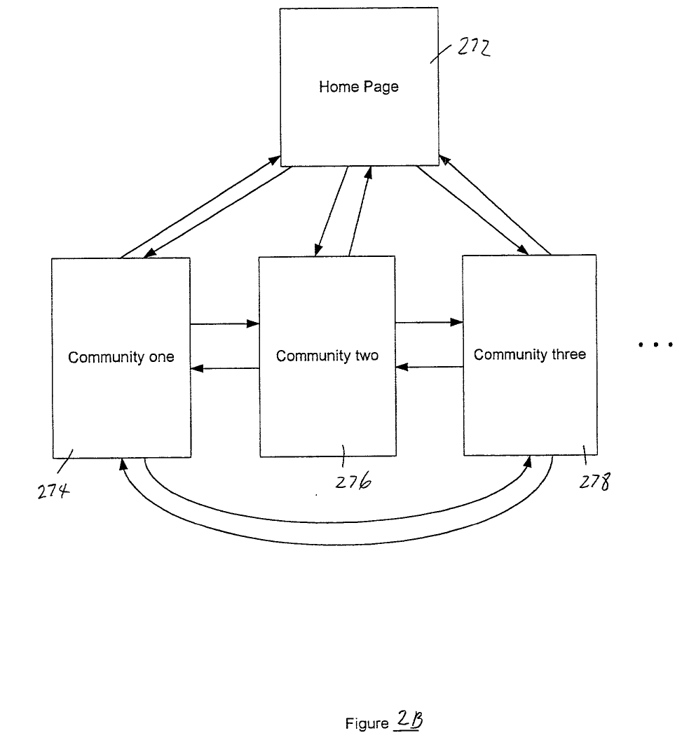

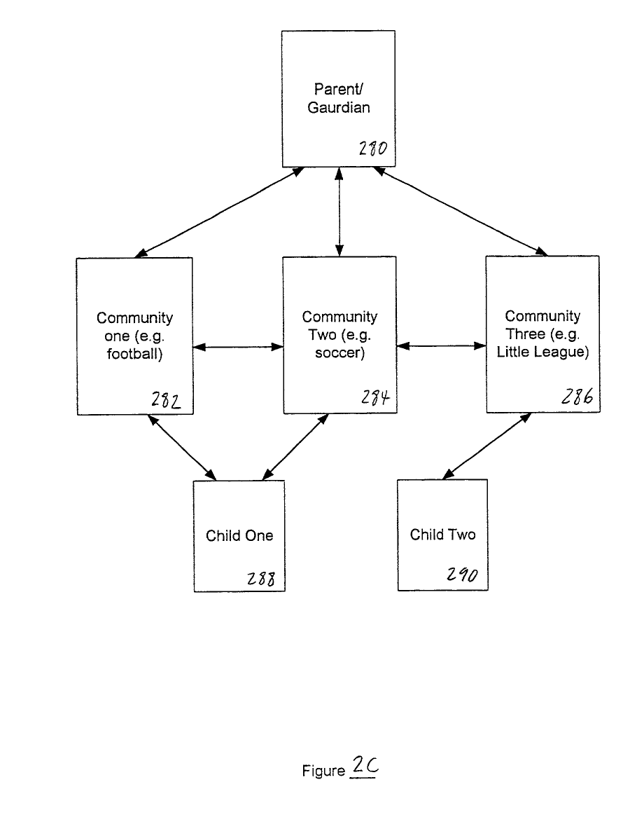

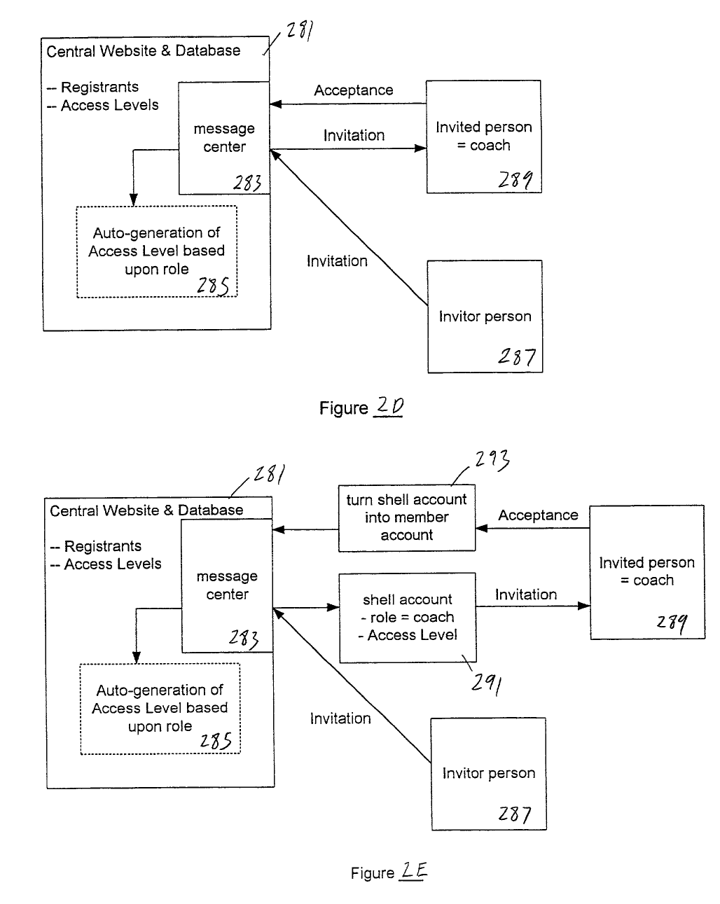

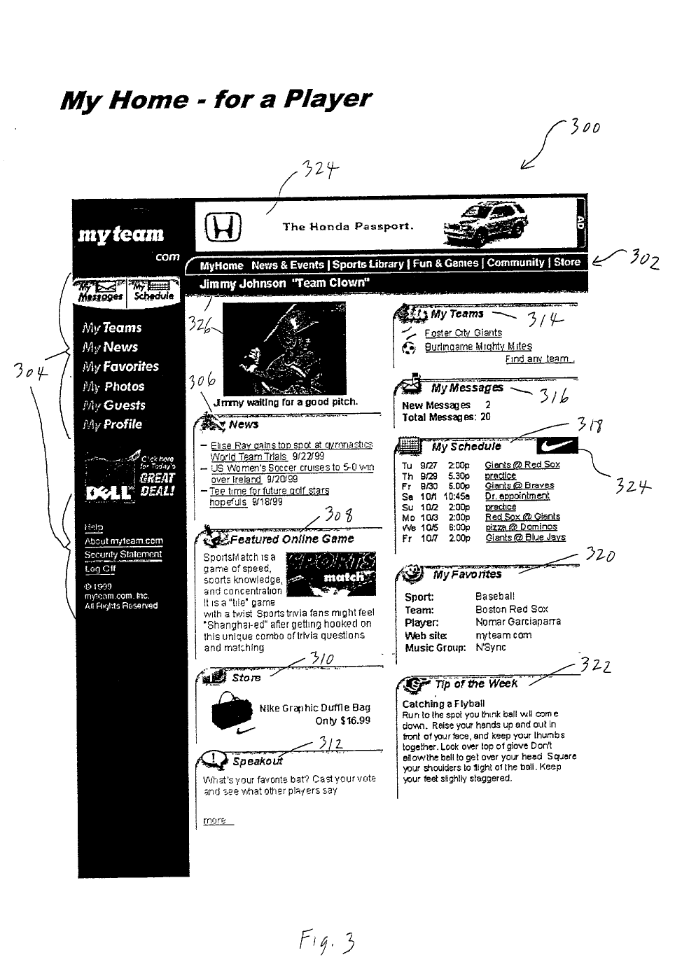

Members of the myteam.com website will be provided an entry point 110, which will prompt the user for their Member-ID and password. Upon entering the system, Members are provided access to three types of mini-site areas, namely My Home, Team Home, and League Home. Each Member can have access to multiple instances of each type of mini-site, as they may have relationships with more than one Team and League. Note that Visitors can also get limited access to the Team Home mini-site, and the League Home mini-site (See FIG. 2 below for access levels).

The Member will be placed (by default) in their own My Home mini-site 112. Also shown are the Team Home mini-site 114, and the League Home mini-site 116. Only Members may access a My Home mini-site. Access is a result of ownership, or via an Invitation from the owner; otherwise even Members cannot access another person's My Home mini-site. Linked pages associated with the My Home mini-site include, for example: My Messages, My Schedule, My Teams, My New, My Favorites, My Fans, and My Profile. Each of these links pulls up pages relating to the listed topics, and which are particularized with information pertaining to the mini-site owner. The information displayed on the My Home mini-site pages will include information that was originally posted on a Team Home mini-site or League Home mini-site when that information is relevant to and otherwise accessible by the individual when they are on the respective Team Home or League Home mini-site. Such information includes messages and scheduled games, practices and events for Teams and Leagues of which the individual is a Participant.

Any team that a Member belongs to, will have a Team Home page and associated linked pages therefrom, comprising the mini-site. Such link pages might include: Team Finder, Team News, Team Schedule, Team Scoreboard, Team Photos, Team Locations, Team Roster, and Team Fans. Each of these links pulls up pages relating to the listed topics, and which are particularized with information pertaining to that Team. The information displayed on the Team Home mini-site pages will include information relevant to that Team that was originally posted on a League Home mini-site, if that Team is part of a league. Several of these pages themselves have links to editable versions of the pages or other tools that modify the contents of these pages. These editing tools and the links to them can collectively be referred to as League Tools 126, of which a subset are relevant to a Team, and are only accessible to the Team Administrator(s).

The Team might also be part of a larger League, and which has a League Home page. The Participant belonging to this Team is also granted Participant access to the League Home page, with any linked pages therefrom comprising the mini-site. Such links might include: League Finder, League Sponsors, League News, League Scoreboard, League Photos, League Locations, League Profile, League Teams, League Members, and League Fans. Each of these links pulls up pages relating to the listed topics, and which are particularized with information pertaining to that League. The information displayed on the League Home mini-site pages will include information relevant to that League that was originally posted on a Team Home mini-site if that Team is part of the League.

Several of these pages themselves have links to editable versions of the pages or other tools that modify the contents of these pages. These editing tools and the links to them can collectively be referred to as League Tools 126, and are only accessible to the League Administrator(s).

There also exist links to transition between the three mini-site Page areas. A My Teams capsule is generally provided on a user's My Home page. By clicking on a link associated with a Team name in this capsule, the user will be linked over to the Team Page for that team. On the Team Page, there will exist a link to League Page associated with that Team. Both the Team Page and the League Page might also include a link to an even higher organization. For example, for a Little League (LL) team belonging to a local League, the Team Page and the League Page might include a link to www.littleleague.org, which is the public website for all of Little League.

Each mini-site will present a variety of information, which generally includes Photos 118, News 120, Schedules 122, and Scoreboard 124 information. The discontinuous line 130 associated with the Photos information 118 shows that photos will be particularized for each mini-site, and information will not be passed there between. Hence, “local” photos pertaining to the owner, the Team, or the League will be shown on each mini-site. Varying levels of photo crossover are intended to be included within the scope of the present invention. The ability for an individual to view photos will be constrained by each individual's security access to the information on the respective mini-site that the photos originated on. The discontinuous line 132 associated with the News information 120 indicates that different types of news will be shown for each different mini-site, without passing of information there between. For instance, the My Home news might include a National news feed. Team news is written and submitted by a Team Administrator. News that is on the League Home page is submitted by the League Administrator. Varying levels of news crossover are intended to be included within the scope of the present invention. The ability for an individual view news items will be constrained by each individual's security access to the information on the respective mini-site that the news originated on. The continuous line 134, with bi-directional arrows between the mini-sites Team Home and League Home, indicates that Schedule information will be shared between the mini-sites. Scheduled games and practices entered by a Team will be accessible on the League Home page. Scheduled games, practices and events entered on the League Home and Team Home will be accessible on the My Home page of a Participant in the Team and League. The continuous line 136 spanning the Team Home and League Home mini-sites indicates that Scoreboard information will be shared between the Team Home mini-site and the League Home mini-site. Game scores and related details can be entered in the Team Home for the team's that played in a game and the information entered will be available on the League Home pages and the Team Home pages for either team that played in the game. Likewise, a game score can be entered in the League Home and will appear in the Team Home pages for both of the Teams that played in the game.

It should also be noted that much of the content in the general content area, i.e. information that Visitors can see, will be seeded (or linked) into the various Home pages, and capsules therein. For example, a “tip of the week” listed on a My Home page is really going to lead the user (i.e. the Member) over to a page (or information) residing underneath the “Sport Central” tab. This serves to distribute over the various Home pages, the wealth of information that is found in the general content areas in a manner that is convenient and personalized, without the Member having to backtrack through the myteam.com general website. The topics of information displayed on the different Home pages is determined by the sports and respective roles that are chosen by the individual in a preferences page, and by the sport of the respective Team or League on whose home page the capsule is being displayed.

Any number of exceptions might also exist from the structures described above, and still remain within the scope of the present invention. For example, a League Administrator may not initially arrive into their My Home Member page upon log-in to the myteam.com site. Instead, this League official will find it more convenient to be directed initially to the particular League Home page over which they preside. A League President (or the like) can also use a My Teams capsule that is generally presented on every My Home page to quickly jump over to the League Home area.

As noted above, there are publically viewable Team and League Home pages available for Visitors. These users, however, do not see a number of the capsules that are located on the pages. In general, the present system preserves a certain level of privacy when dealing with certain capsule information. Since the present sports-oriented website deals with youth, and youth-oriented activities, it becomes important to limit certain access to such Visitors. In might be detrimental if a Visitor were able to freely access practice schedules, pizza party information, or photographs of a particular child. Various examples of prior art do allow free access to such youth-oriented information. For instance, visitors to such prior art sites are able to freely access telephone numbers of League Officers and Administrators. Also, such visitors can access photographs of children and children's names posted on the website, and the like. This is unacceptable under the present invention, and access is limited based upon the security status of the individual accessing the site.

Referring now to FIG. 2, an access level chart 200 is shown with four (4) key access levels in relation to the My Home, Team Home, and League Home web pages. Certain fundamental concepts behind the formation of the Community aspects of the present invention were derived (in part) from security models. Aspects of security access were taken and incorporated into determining the population of the Community. Hence, the present system pre-defines the access levels in relation to the Community relationships, and combines them into a consistent model. When an individual is invited or added to a Team or a League, their security access is pre-defined based on the role in the Community to which they are added. The types of Pages (i.e. My Home, Team Home, and League Home) are shown on the vertical axis, and are charted against the types of users (i.e. Non-Members and Members). Non-members would include the Anonymous Visitor (Spectator or Visitor). Members would include the Invited Guest (Fan/Friend), Participant, or Adminstrator. The Invited Guest is also referred to as a Fan or Friend. A Fan is also an invited guest of Team Home or the League Home pages.

The My Home page is the most private of the mini-sites, as it contains the personal information of the registered Member of the myteam.com site. In general, nobody can see such information except the Administrator (i.e. the owner), or a Member who has been invited by the Administrator to view the information. As shown by the chart in box 202, no access is allowed to a My Home page for an Anonymous Visitor. Proceeding right, box 204 shows that an Invited Guest (or Fan/Friend) is allowed access to the My Home page. Box 206 shows access is allowed for a Participant who is a verified family member, such as a parent or guardian. Box 208 indicates that the Administrator of the My Home page is the owner, and hence full access is allowed.

The Team Home page allows slightly more access to the different types of users. In box 210, the Anonymous Visitor is allowed limited access to the page. Limited access means that only certain capsules on the page are viewable, and the more private the nature of such capsules, the more likely that they will be precluded from being viewed by a Non-Member. When an Anonymous Visitor views the Team Home page, there will be an information capsule that will list the name of and provide a link to send an email message to the person who is the designated contact for the Team. A “bookmark this team” button or link will add the Team Page to the list of teams on both the My Teams capsule and My Teams page of the Anonymous Visitor. If the Anonymous Visitor wants to be added as an Invited Guest to this page, then the Visitor might click on a “request invitation” button that would notify the Administrator of the request to be sent an Invitation. Alternatively, the Anonymous Visitor may email John Doe and request that the visitor be sent a personal Invitation (and Invitation-Number). The Administrator (i.e. John Doe) will then send such an Invitation to this Visitor if they know and/or trust the Visitor. Additionally, a Team Administrator might be pro-active and gather up all of the parents names, or owner(s) of a sponsoring company, and so forth, and send such persons an Invitation.

Invitations might also be automated in certain respects, in that parents, authorities, or contributors can be sent Invitations automatically by the system. Yet another automatic feature might allow Invitations to be sent out to all the other teammates of an individual to grant them access to the individual's My Home page, given that the common membership on a Team provides the level of trust needed to send out an Invitation. This allows for convenient establishment of access rights, so that these Participants on a team can view each other's My Home pages.

In general, when creating Invitations the system could look at what relationship exists between individuals that share some commonality of community with other individuals, and predetermine what type of Invitation to send out. For example, kids on a team would likely give their coach the right to see their My Home pages. However, the coach might not necessarily wish to give the kids the right to see his own My Home page. This situation (and others like it) might prompt a two-way Invitation to be sent out that could be responded to in a one-way fashion. For example, the response to a two-way Invitation would be that the user would like to see the invitor's My Home page, but the user does not want to provide the right for the invitor to see the user's My Home page.

In box 212, the Invited Guest is shown as being allowed to see more information than a Visitor, because the Invited Guest is a trusted individual. The Invited Guest is not offered full access to the Team Home page, but can see more capsules than the Anonymous Visitor. The only way to become an Invited Guest is through approval of the Administrator of that particular Home page. As a result, a self-policing level of security is introduced. In box 214, the Participant is shown to have full viewing access to the Team Home page, as this will be a key viewing area for any Participant on such a team. In many cases, the Team Administrator would be the team coach, and would invite all of the players, their parents and team volunteers to become Participants to view the Team Home page. A Team Administrator will exist for the each team, and box 216 shows that full access (including edit rights) is allowed for such an individual.

The League Home page is similar to the Team Home page, though it contains more information. Box 218 shows that an Anonymous Visitor can see some information, but is limited from viewing certain capsule information. In box 220, an Invited Guest can see still more information. In box 222, a Participant can see still more information. The League Administrator has a large realm of responsibility, and box 224 shows the League Administrator having full access to the League Home page.

At the Team Home level, as indicated by the asterisk, the present system will allow Participants (i.e. players and volunteers) to also be able to see Fan Lists for each team, and to invite other people to be Fans. The Fan List includes both individuals that have been invited and those who have accepted. In general, only the owner of a page gets to see the associated Fan List, and send out Invitations in order to increase overall membership from that Fan List. At the Team level, however, the aforementioned exception is made. Such use of Fan Lists by Participants is self-policing, in that at any time, a Team Administrator can review the Team's Fan List and delete an individual. Deletion of an individual could be based upon certain information known by the Administrator, that may not have been known by the person who placed the person on the Fan List. It is important to have several checks and balances regarding the status of certain individuals, as a wide variety of potentially private information is posted on the Team Home site, including for instance practice schedules, photos, parties, and so forth. Without approval of the Team Administrator, an Anonymous Visitor is generally limited to publically available information, such as game schedules and the like. This use of Fan Lists by Participants will not be allowed, however, at the League Home level. It is believed that the membership of a League is too large and would therefore make it too difficult to adequately police the addition of Fans by Participants in the League.

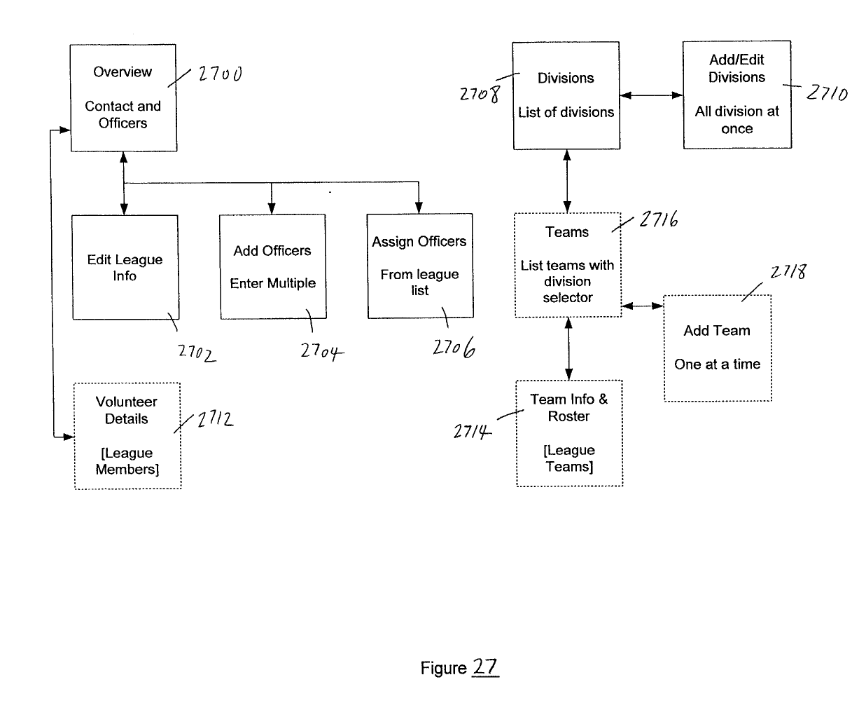

The League Administrator also has access to a set of League Tools (See FIGS. 26-45, described below). Such tools allow the Administrator to enable the league structuring into divisions and teams. The tools also provide for arranging and organizing the teams in those divisions. Different league members (i.e. Volunteers and Players) can also be arranged and organized via such tools. Games, practices and events can be scheduled, and scores compiled into standings.

An alternative viewpoint of the website or information structure is shown in FIG. 2A. An example organizational hierarchy 250 is shown that includes a main (supervisory) organization 252 (such as Little League, or the like). Also shown is a designated authority (DA) 254 (such as Myteam.com) for administrating the organizational hierarchy. Certain example groups such as the leagues 256, teams 258, and players 260 are shown which might be subordinate to the groups above in the hierarchy. The players are shown to include child1 262 and child2 264. Child1 262 is shown to have trusted relationships with persons that might include a sibling, grandparent, Father, Mother, aunt, and/or uncle. Child1 belongs to many different teams, including Team1, Team2, and Team3. Each team belongs to a respective League1, League2, and League3. The leagues are part of (or belong to) the main organization 252. Child1 can send out invitations to any trusted individual. In the example shown, Child1 sends out an invitation to the Father 266, who can thereafter accept the invitation. Upon accepting the invitation, the Father is afforded the opportunity to register with the website and thereby be granted a Home Page 270 as a registered member of the website. This home page can contain a variety of configurable capsules and/or window areas for information. Example capsules shown include My Schedule, My Teams, and My Leagues. In each appropriate window, information is shown for the Father's various children (i.e. child1, child2) and the teams and/or leagues that the Father has chosen to include on the Home Page. As such, the Father will be able to view—in one convenient location, as a registered member of the website with his own Home Page—information such as practice and/or game schedules for his children, and/or any other information the Father deems of interest. As each team or league changes such schedules the information will be accurately reflected on the Father's Home Page. The access level as to what types of information that the Father can ultimately view is dictated by the Father's role or relationship to the child.

FIG. 2B shows an example of the resulting Home Page 272 that is created for each registered website user. First, second, and third example community areas 274, 276, and 278 are shown in communication with the Home Page. Each of the community areas are in communication with each other, based upon the trading of information between the communities, as based upon the hierarchy between the community areas.

FIG. 2C next shows a example block diagram of the parent (or guardian) 280 in communication with three different community areas, i.e. football 282, soccer 284, and Little League 286. Child one 288 is shown belonging to both the football and soccer communities. Child two 290 is shown belonging to the Little League community. Accordingly, the parent/guardian is able to participate in the same communities areas as their children, via one collective view area, namely their Home Page as created by their registration on the website.

FIG. 2D next introduces the concept of the central website system and/or database providing for (optional) auto-generation of an access level based upon the role of the person being invited to join the website. The central website and database 281 will store information such as the registrants and their access levels. The website 281 is shown to include a message center 283 and a module (i.e. hardware, software, and/or code) 285 for automatic generation of the access level. The invitor person 287 sends out an invitation that passes through the website's message center 283 and is routed to the invited person 289. In this example, the persons role =“coach.” When person 289 accepts the invitation, the module 285 is invoked to generate the access level based upon this role.

FIG. 2E shows a similar configuration as that shown in FIG. 2D. In this instance, however, the invitation to person 289 causes a shell account 291 to be created which contains, among other things, the role and access level of the person being invited. Upon acceptance, block 293 is shown turning the shell account into a member account.

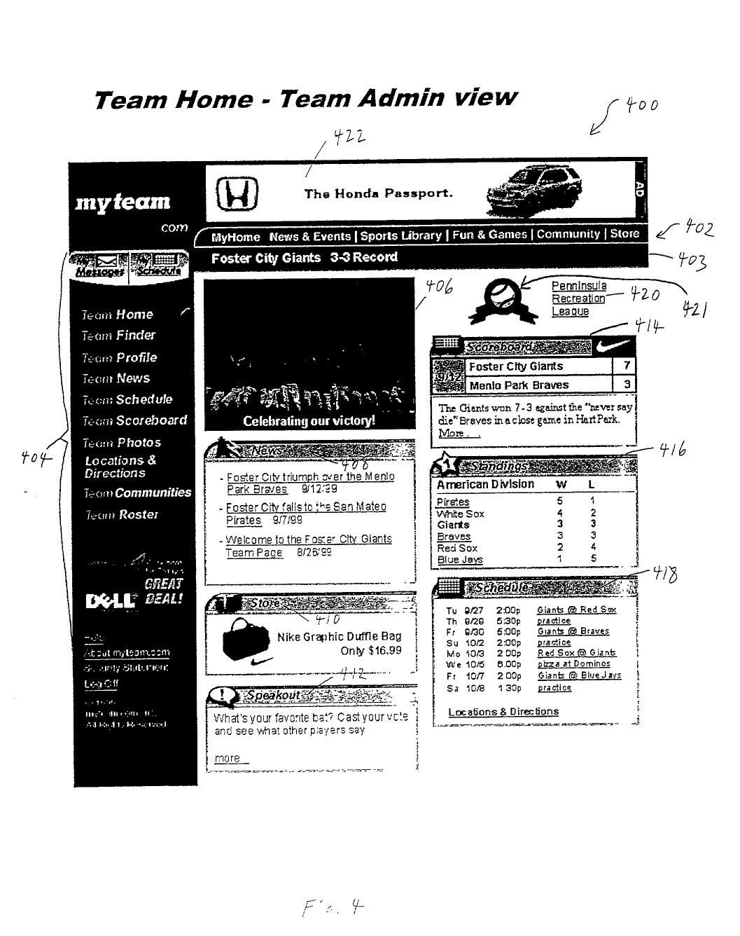

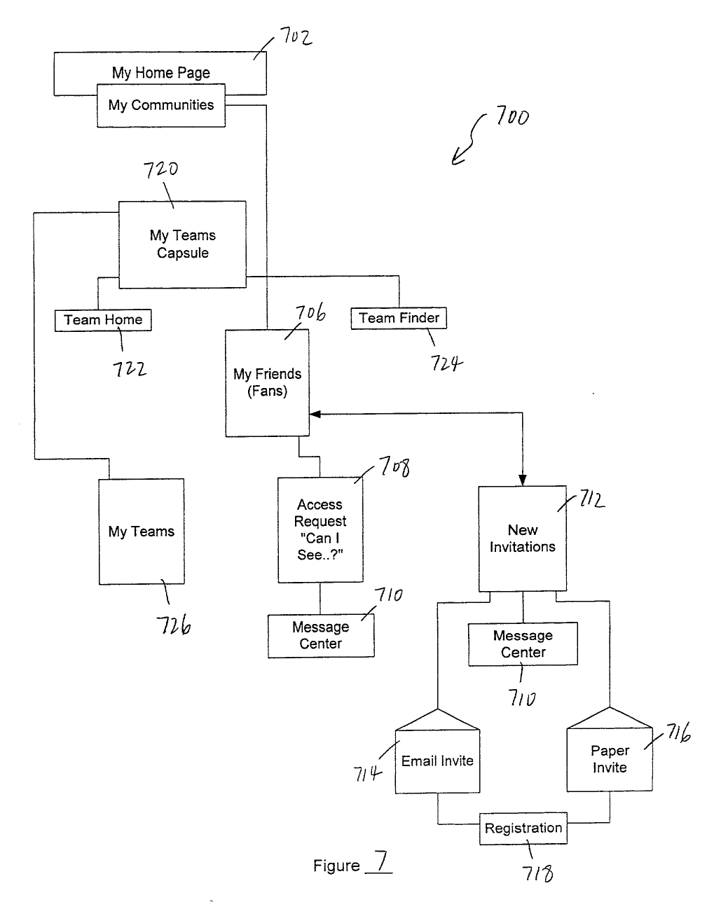

Referring now to FIG. 3, a representative webpage 300 is shown of the My Home page for a player on a team. The various general information tabs 302 can be accessed from the upper border. Click-through hyperlinks 304 to the other pages of this mini-site are available on the left border, or navigation bar. Various capsules are shown on the page, including news 306, online games 308, store 310, polls 312, My Teams 314, My Messages 316, My Schedule 318, My Favorites 320, and instructional information 322. Personalized information 326 is shown regarding the owner of this page (Jimmy Johnson), including for instance pictures of the Player in action, or captions regarding the Player's nickname. Advertisements 324 are also interspersed (in available spots) across the page. As noted above, the My Teams capsule (or click-through to a My Teams page), allows quick access to the Team Home and League Home pages for the various teams with which this Player is affiliated. The My Teams capsule also includes a “Find any team” click-through link 315, as further described in association with FIG. 6.

The My Messages Capsule and the My Messages page contain all messages sent from individuals who are also Members of the website and from the Administrators of the different Teams and Leagues in which the individual is a Participant. The My Schedule Capsule and the My Schedule page contain all scheduled personal events and all scheduled games, practices and events for the different Teams and Leagues in which the individual is a Participant. The My Schedule Capsule displays only the most current, forth-coming scheduled items, and acts as a summary of the full listing of information that is available on the My Schedule page. The My Schedule page displays all scheduled items in a similar manner as the Capsule, but with no restriction of quantity. In addition, the My Schedule page displays a location name for each scheduled item. Clicking on the scheduled item name in either the My Schedule Capsule or page will go to the detailed information page for that scheduled item. If the individual has edit access rights to the information being displayed, an “edit” access link will be displayed that will lead to an editable version of the page. On the My Schedule page, the location name will be a link to detailed information about that location if any is available in the Locations & Directions part of the Team or League mini-site. If the individual has edit rights to the location information being displayed, an “edit” access link will be displayed that will lead to an editable version of the page.

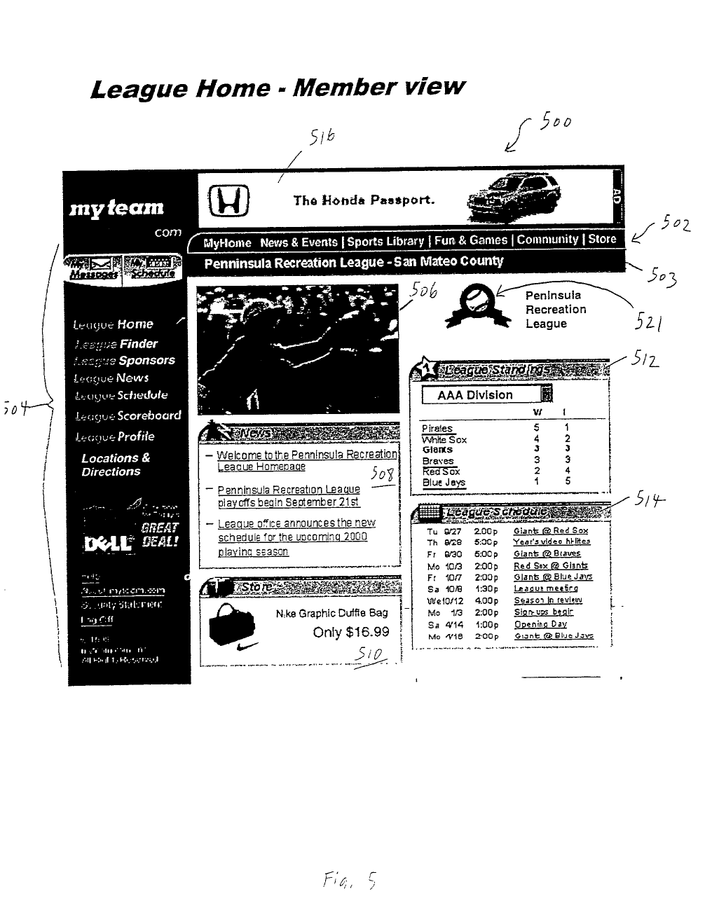

Referring now to FIG. 4, a representative webpage 400 is shown of the Team Home page for a particular Team. The shown view is from the access vantage level of a Team Administrator. As before, the general information tabs 402 are available on the upper border, along with a caption 403 identifying the Team (Foster City Giants). Click-through links 404 to the other pages of this mini-site are available on the left border, or navigation bar. The various Capsules on the page include Team Photos 406, Team News 408, store information 410, polls 412, Scoreboard information 414, Standing information 416, and Schedule information 418. Again, advertisements 422 can be included in available spots on the page. A click-through link 420 is also included to provide convenient access to the League Home page associated with the particular Team. A click-through link 421 is also included to the external website of the parent organization if this team is part of a larger sports organization, such as Little League Baseball.

The Team Schedule Capsule displays games, practices and other events that are scheduled by either the Team or by the League that the team is in. The Capsule presents a summarized view of the information that is displayed on the Team Schedule page that can be accessed by clicking on the top of the Capsule or by clicking on the respective button in the navigation bar. The Standings Capsule displays the won-lost record of each Team in the same division as the Current team. The won-lost record is a summary based on the calculations of all of the game scores that have been entered by the League and by the other Teams in the same division. The Scoreboard Capsule displays the score and a brief description of the most recent game that has been played. More detailed information on the specific game can be accessed by clicking on the “more . . . ” link. Clicking on the title bar of the Scoreboard or Standings Capsules will go to the Team Scoreboard page which displays all of the game scores. The News Capsule displays the 3 most recent news stories that have been entered by either the Team Administrator or a League administrator or its League. Clicking on a specific news item will display the full news article. Clicking on the title bar of the News capsule will go to the Team News page from which all current news articles created by the Team Administrators is displayed.

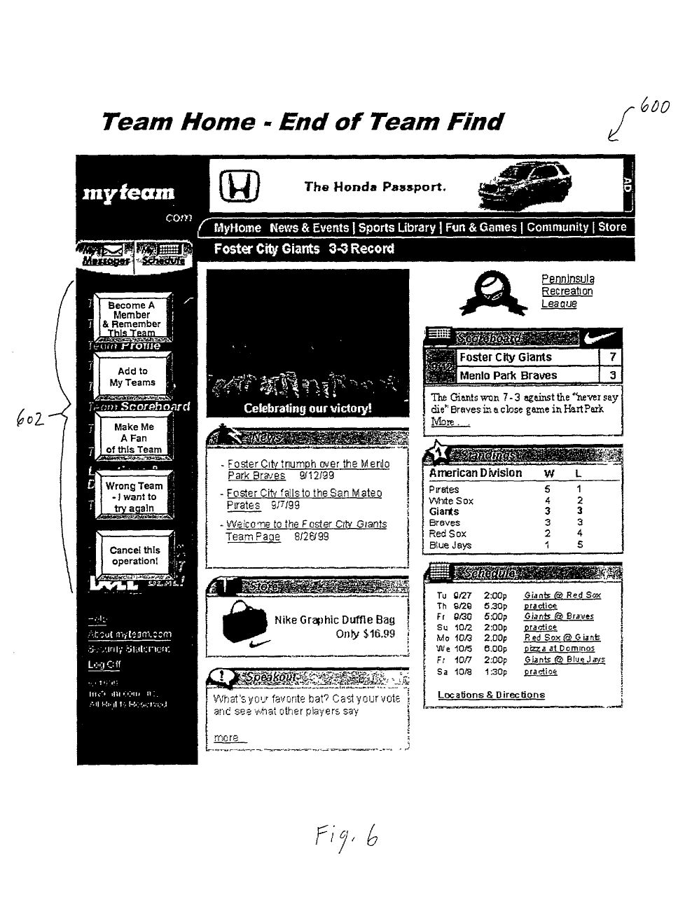

Referring now to FIG. 5, a representative webpage 500 is shown of the League Home page for a particular Team. The shown view is from the access vantage level of a League Participant. Once again, the general information tabs 502 are available across the upper border, along with a caption 503 identifying the League. Click-through links 504 are available for access in the navigation bar area. The various Capsules associated with the page include: League photographs 506, League News 508, store information 510, League Standings 512, and the League Schedule 514. Advertisements 516 are similarly included on the page 500. The League logo 518 is also shown to further identify the page and to optionally provide a click-through link to a League's parent organization external site. A click-through link 520 is included to the external website of the parent organization if this team is part of a larger sports organization, such as Little League Baseball.

The League Schedule Capsule displays games, practices and other events that are scheduled by the League and games that are scheduled by Teams within it. The Capsule presents a summarized view of the information that is displayed on the League Schedule page. The League Schedule page can be accessed by clicking on the top of the Capsule or by clicking the respective button in the navigation bar. The Standings Capsule displays the won-lost record of each Team in the same division as the Current team. The won-lost record is a summary based on the calculations of all of the game scores that have been entered by the League and by the Teams in the currently selected division. Clicking on the title bar of the Standings Capsules will go to the League Scoreboard page that displays the most recent, and provides access to all of the game scores for the League. The News Capsule displays the 3 most recent news stories that have been entered by either the League Administrator for its League. Clicking on a specific news item will display the full news article. Clicking on the title bar of the News capsule will go to the League News page from which all current news articles created by the League Administrators is displayed.

Referring now to FIG. 6, a representative webpage 600 is shown which might result from invoking the “Find any team” link 316 from the My Teams capsule of FIG. 3 above, clicking Team Finder in the navigation bar of a Team Home page, or by clicking League Finder in the navigation bar of a League Home page. This search has located the team “Foster City Giants,” as was specified by the user. The resulting page is similar to the Team Home page for the located Team, with a few exceptions. A list of additional options 602 is produced for this page, and presented via click-through boxes which are oriented in the navigation bar area, and superimposed over the previously listed click-through links. Having found this Team, the user is given a range of options relevant to their membership status in the myteam.com site. The options could include (but are not limited to): Become a member & remember this Team; add the Team to the player's My Teams area; request to be made a fan of this Team; try a search for another Team; or cancellation of the “find any team” operation altogether.

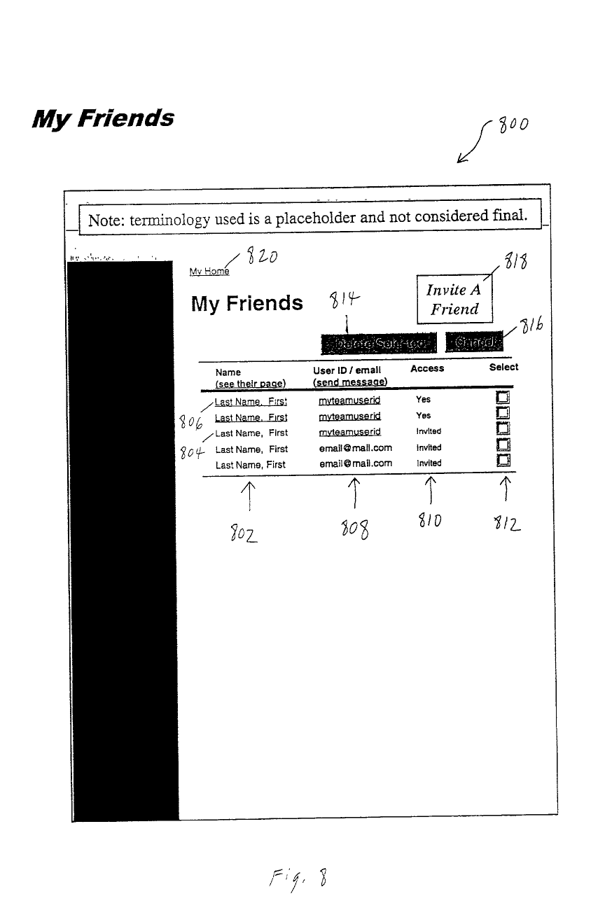

The interaction of the various features on the myteam.com website can further be illustrated by the site flow map 700 as shown in FIG. 7. The user enters the map via the My Home Page 702. A My Communities click-through area 704 in the navigation column (i.e. the left-most column on the My Home page) links to access an area shown as My Friends (or My Fans, or My Guests) 706. My Friends (Fans) is a list of people with whom the user has a relationship. Exceptions (i.e. names not shown) might include those people that are on the same Team as the user. If all persons are so listed, then exploration of the Team's roster page will indicate which person's on that Team have a sharing relationship with the user. This My Friends list provides a form of “bookmarking” between a user's site and a Friend's site, and indicates whether the relationship is reciprocal, a Friend only sharing with user, or the user only sharing with Friend. If a Friend is listed in My Friends and the name is a link, then permission to view the other sites has already been granted. If a Friend is listed in My Friends and the name is not a link, then the Friend has permission to view the user's page, but the Friend has not granted permission to the user to view their site. If such permission has not been granted, a request can be formed via step 708 wherein the Fan asks the My Home page owner whether they can see various aspects. The request may be forwarded (or handled) through a message center 710.

The My Friends list can also be used by the My Home Page Administrator to send out a new Invitation 712 to persons on the list. The Invitation might be in the form of: “see my page,” or “let's share pages,” or “join myteam.com.” The Invitations are forwarded (or handled) through the message center 710. The email Invitation can be broadcast from the myteam.com site, with the myteam.com return email address. Alternatively, the email Invitation might be sent directly from the invitor, so the invitee can respond directly via email. The Invitation might be handled in the form of an email Invitation 714, or in the form of a paper Invitation 716. The Invitation (with its associated code number) can be used by the person receiving it to complete registration 718 with myteam.com, and subsequently gain access to the My Home page of the Administrator.

Note that a person can become an Administrator through several means. For a My Home page, the person that created that page through the registration process is its Administrator. Otherwise, at the League level, the League President will generally determine who is going to be the League Administrator (or may also appoint multiple Administrators). When the League Administrator populates the membership of that League, with both volunteers and players, and populates the League structure by creating divisions and the like for the teams, the League Administrator is prompted to create an Administrator for each individual Team. If a Team has no formal relationship with a specific League, known as an “Independent Team”, and chooses to become associated (added to) with the myteam.com site, then the person who adds the Independent Team is (by default) the Team's Administrator. Likewise, if a League is created, the person who adds the League and any Teams in it is (by default) both the League Administrator and the Team Administrator for any Teams created in the League. If, however, a Team is added into an existing League, while the person who added the Team is by default the Team Administrator, the League Administrator has superior rights and can over-ride or revoke the rights of the Team Administrator. Ultimately, the myteam.com site has super-administrative powers, and is able to give control to the proper person who should exercise League Administrative powers in any given situation.

Referring again to FIG. 7, a My Teams Capsule 720 is shown, which would be found on the My Home page 702. The My Teams Capsule 720 offers the option to click-through on Teams that are listed. In doing so, the user will be taken to the Team Home page 722 for that particular team. It is intended for the name of a league to be displayed next to a team that is in it, or a league by itself if the participant only has a role in a league. Additionally, the Team Finder option 724 might be used to find a particular Team. The user can also click-through to the My Teams page by clicking on the header of the My Teams capsule 720. The My Teams page displays the teams listed in the My Teams capsule, plus any additional Teams that do not fit on the Capsule and the Teams' respective Leagues.

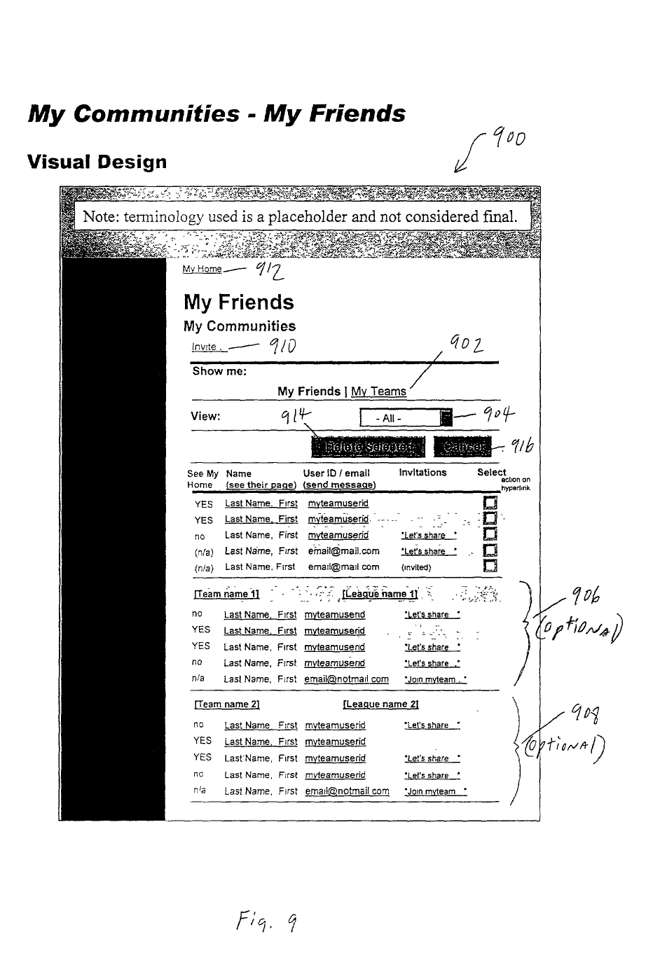

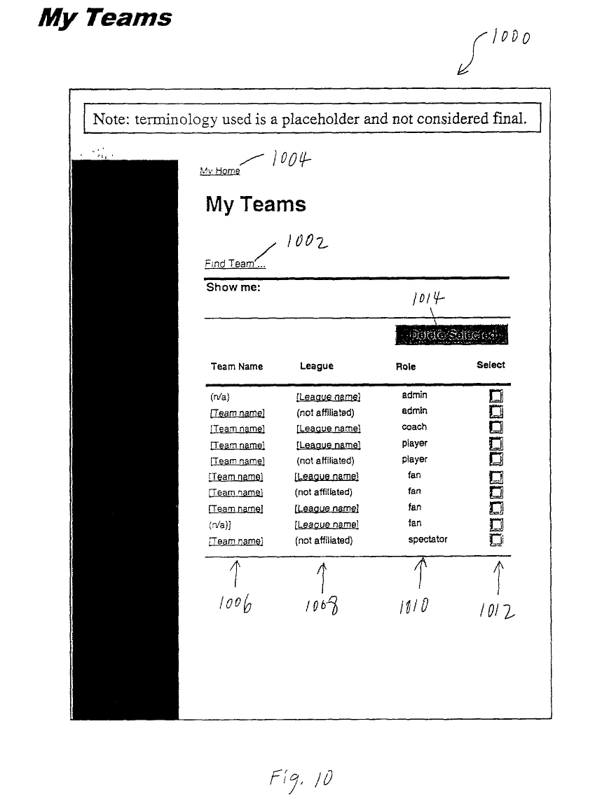

Referring now to FIG. 8, a first version of a My Friends web page listing 800 is shown. This page is the initial page that comes up when a user clicks on “My Communities” in the navigation column (i.e. the left-most column) on the My Home page. This page is viewable only by the owner of the page. The page is capable of displaying multiple tables, all sharing the same column headings. This first My Friends version shows a first table which displays “friends” who are people that the user has invited to be myteam.com Members, or other myteam.com Members with which the user has a relationship. Members of the Team that the user is a Participant in might be excluded. These “friends” are people that can see the user's My Home page, and vice versa. Subsequent tables are described in association with the alternative version of the My Friends web page (FIG. 9 below).

In the first column 802, a listing of the names of the persons on the My Friends list is shown. If a name is not underlined or highlighted, i.e. name 804, then a click-through cannot be performed. If the name is underlined or highlighted, i.e. name 806, then permission has been granted by that person to see their My Home page. The user can thereby click-through on the name in order to see that person's My Home page. In column 808, the Member-ID or email of the listed persons are shown. The underlined or highlighted “myteamuserid” can be used to click-through and send a message to that particular myteam.com Member, through the myteam.com messaging system. Column 810 shows the access level for each listed name. If “yes” is shown, then the current Member has granted the person click-through access to their My Home page. Otherwise “n/a” might be shown if the current Member has not granted the person access to their My Home page and/or if the person is not a myteam.com Member. An “invited” status is shown if an Invitation (i.e. a reciprocal Invitation) has been sent to see the listed person's My Home page. Column 812 shows a “select” option which shows a checkmark if a name is selected. The “deleted selected” tab 814 deletes the selected names from the My Friends list, resulting in their access to the current user's My Home page being terminated. The “cancel” button 816 serves to cancel the selection of any names. A button 818 for “invite a friend” facilitates sending an Invitation to Friends that are not on the list. A link back to My Home 820 is also shown.

Referring now to FIG. 9, an alternative My Friends web page listing 900 is shown. In this arrangement, the user is given the option to select between a showing of My Friends or the listing of Teams the user is involved with via the click-through selector 902. A drop-down menu 904 is also shown for selecting which grouping to view. The drop-down values might include: All, Friends, Team1, Team2, and so forth. The listing of My Friends includes click-through names to see that person's My Home page, and click-through Member-ID (“myteamuserid”) to send that person a message (as above). The access level is shown in the “See My Home” column. The Invitation column includes the type of Invitation (and indication of status). As before, names can be selected, deleted, or canceled via the corresponding selection boxes and control tabs. This arrangement also includes (optional) team listings for Team 1 (906), and Team 2 (908). These listings include fellow teammates on the particular team (and league) shown. An “invite” hyperlink 910 links to the Invitations page, where additional friends can be invited. A “My Home” hyperlink 912 links back to the My Home page. The “delete selected” button 914 removes the people that were selected from the table. The “Cancel” button 916 returns the user to the page from which they came without taking any action.

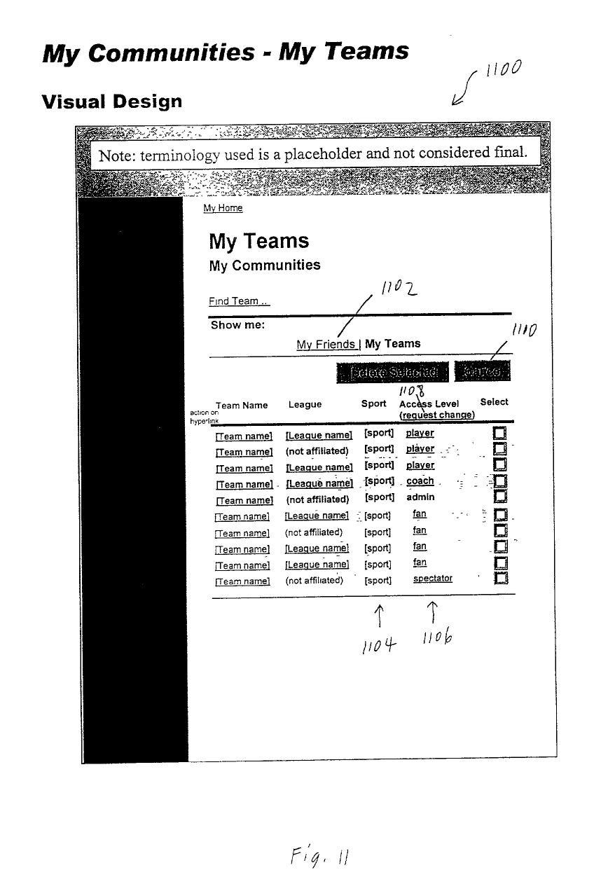

FIG. 10 shows a first version 1000 of a My Teams web page listing. This is the destination page if a user clicks on the My Teams capsule header. In this first version, a “Find Team” hyperlink 1002 is shown, and a My Home hyperlink 1004 is shown. A table is shown with Teams listed and sorted according to the role of the user in relation to that Team. For instance, Teams on which the user is an Administrator are listed first, and so forth. In column 1006, the Team names are shown, with hyperlinks to various Team Home pages. In column 1008, the League Names are shown, or an indication of “not affiliated” if no such affiliation exists for a Team. It is intended that a League in which a Team on the list resides and the Member is a Participant in will also be listed by itself in its own row. This would facilitate the selection of that League independently of the Team, as referenced in Column 1012. Column 1010 shows the role that the user has regarding each Team (i.e. Administrator, coach, player, fan, or spectator). Column 1012 provides the ability to select each Team from the My Teams list, and button 1014 facilitates deletion of the selected Teams from the table. Deleting a Team or League from this list will also remove the individual from having an relationship of Invited Guest, Participant or Admin access to that Team or League. The individual will not see a checkbox next to any Team or League listing for which they are the only Administrator.

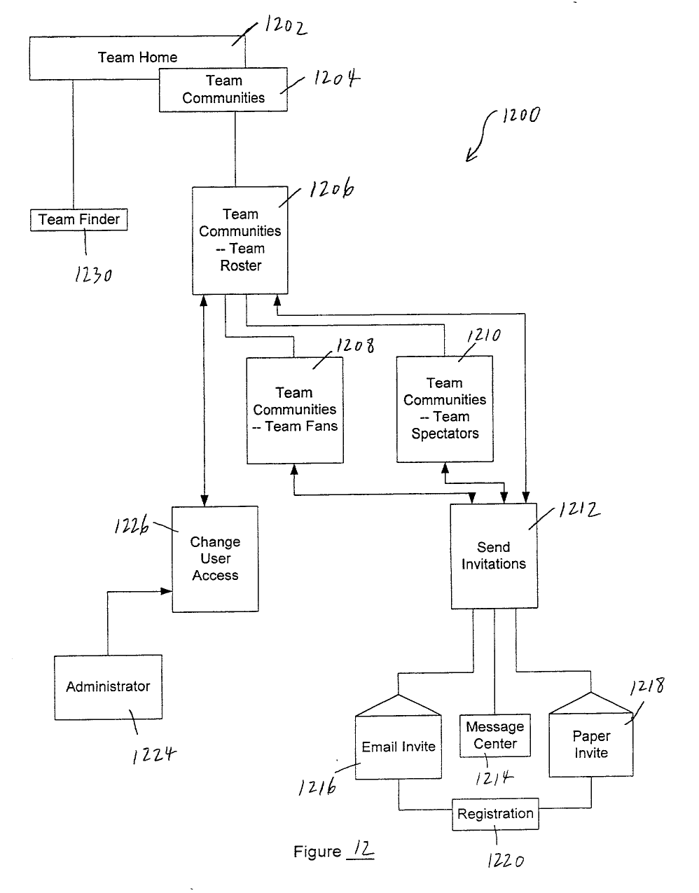

FIG. 11 shows an alternative version 1100 of the My Teams web page listing. Features not found on the previous version include a My Friends hyperlink 1102 which goes to the My Friends page. In column 1104, the sport is listed for each Team. A table is shown with the Teams and Leagues of which the Member is an Administrator for listed first, bolded, in a different color, and sorted alphabetically by team name. Following this are Teams of which the user is a Participant, sorted alphabetically, and so forth. Column 1106 shows the access level of the user in relation to each team listed. Each of these is hyperlinked 1108 to the Access Request page, except for Administrator. A Cancel button takes no action on any selected Teams, and returns the user to the page from which they originally came.

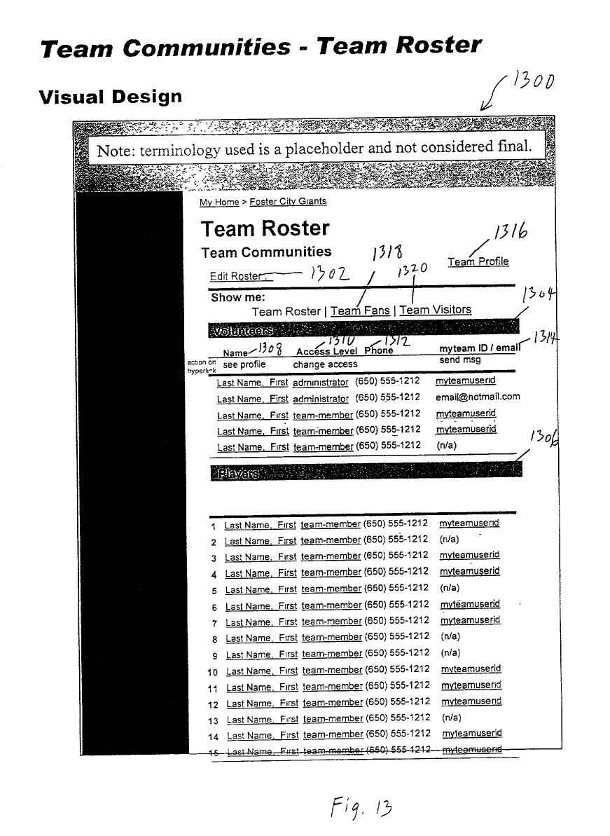

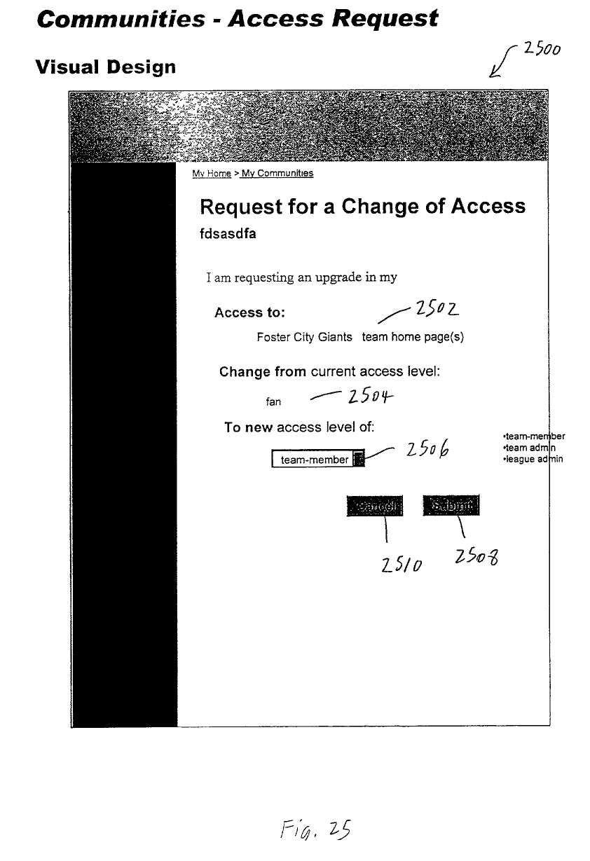

Referring now to FIG. 12, a flowchart 1200 is shown of representative elements associated with the Team Communities site flow map. A user enters the mini-site from the Team Home page 1202. A Team Communities hyperlink 1204 is accessible from the navigation bar area on the Team Home page. The Team Communities hyperlink brings up the Team Roster 1206. From the Team Roster 1206, a Team Fans page 1208, or a Team Spectators (also “Team Visitors”) page 1210, can be accessed. From each of these lists (1206, 1208, and 1210), invitations can be sent out to the persons on the lists. Such invitations may be facilitated by a message center 1214, or the invitations may be broadcast in bulk from the myteam.com website. Either email invitations 1216 or paper invitations 1218 can be sent out (which will include an Invitation-Number, as before). The recipient can thereafter use the Invitation-Number to complete the registration process 1220. On various pages with user listings, hyperlinks will provide the ability for the Admin 1224 to Change User Access 1226 for that user (See FIG. 24).

A Team Finder hyperlink 1230 can also be invoked from the Team Home page 1202. If such a Team Finder is used to find a team or league, additional buttons can be provided to facilitate requests for status changes in relation to that team or league. The Team Finder allows the user to browse through a listing of Leagues, sorted by geographical location (country, state), sport, and alphabetically. Upon selecting a league, a list of the teams in that league are displayed.

The Team Spectators (“Team Visitors”) page shows people who are not Invited Guests, but have requested to be granted Invited Guest status. The Administrator would thereafter go through the list and select which ones to approve and then invoke the grant access function which would also result in an invitation being generated for those who are not yet members of myteam.com. A change of access operation is provided on the Team Fan and Team Roster pages for each individual listed who does not have administrator status. This enables access levels of Participant and Owner (Administrator) to be granted to those who already have at least Invited Guest access. Likewise, an individual's access level can be set to a lower value than they currently have, such as an Owner can setting a Participant's access to Fan due to undesirable conduct on the Community site.

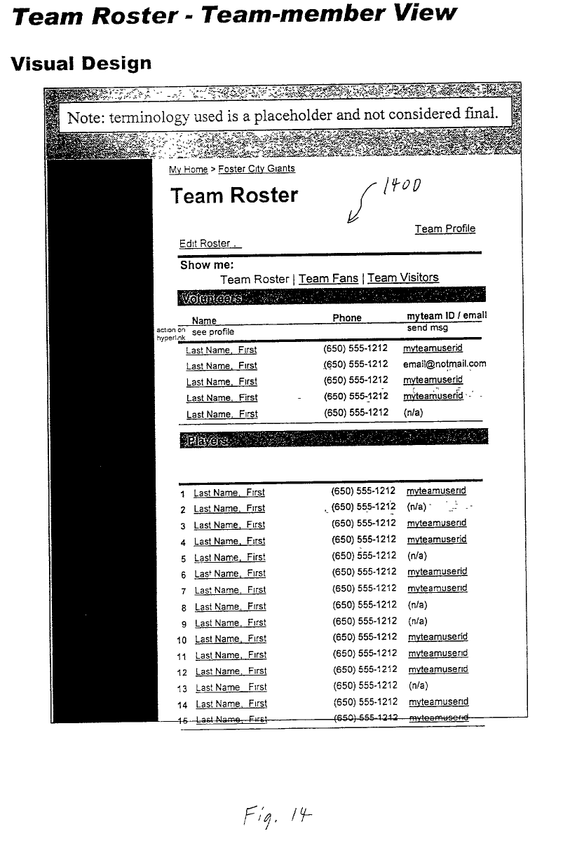

Referring now to FIG. 13, a representative version of the Team Roster web page 1300 is shown. This is the initial page when the user clicks on “Team Communities” in the navigation column of the Team Home page. This version of the Team Roster page is viewable only by the Team Administrator and focuses on the functionality of enabling the Administrator to communicate with the listed persons, and to invite the persons to become myteam.com Members. To be able to delete and add members to the roster, the user must click on the “Edit Roster” hyperlink 1302, to thereafter go to the Team Members—Team Administrator View (Unaffliated) which is further described in League Tools (See FIGS. 26-45 below). The shown view is one of many possible views for a Team Roster, including for instance the League Administrator view, and the Team Administrator view for Unaffiliated. Two tables 1304 and 1306 are shown having Team Volunteers (coach, administrator, field crew, etc) followed by Team Players. Both tables share similar columns.

As an alternative version, rather than having separate tables for players, volunteers, and the like, a field (not shown here) could be included which would indicate the role of the listed person. Hence all persons will be included in one long listing, with the role indicated for each such person. Such roles might include: coach, administrator, team parent, field crew, player, and the like. As one example, the listings might be sorted according to such roles.

The Team Roster columns include a name column 1308, with each name having a hyperlink to that particular person's information page. An access level column 1310 includes a hyperlink to the Change access page. Values for the access level might include: coach, administrator, team-member, and so forth. Column 1312 shows the phone number for each listed person. Column 1314 shows the myteamuserid or email for each person on the Roster. The myteamuserid's are hyperlinked to the myteam.com message center, whereas the email addresses are not hyperlinked. “N/A” might also be shown if the person is not affiliated with myteam.com, or does not have an available email address. Additional hyperlinks and buttons are also shown for the Team Roster page. A Team Profile hyperlink 1316 provides a direct link to the Team Profile page. A Team Fans hyperlink 1318 provides a direct link to the Team Fans page. A Team Visitors hyperlink 1320 provides a direct link to the Team Visitors page.

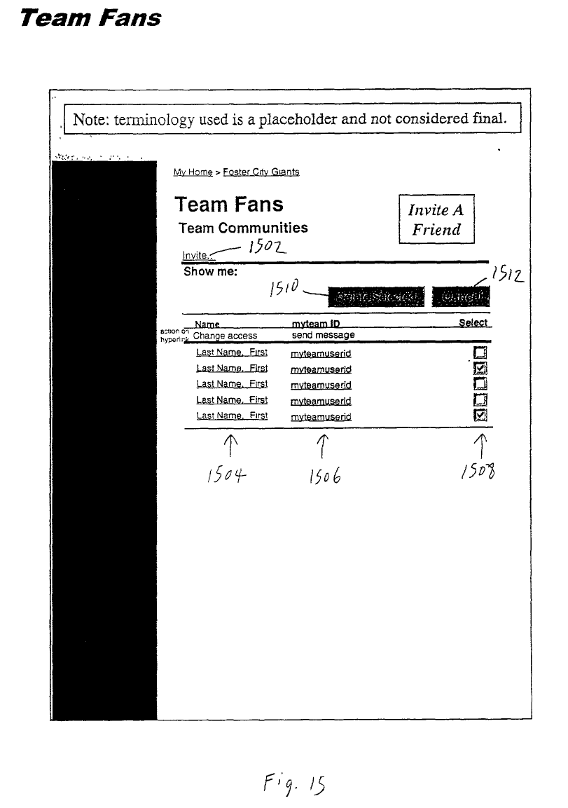

FIG. 14 shows another Team Roster web page listing 1400, but in this instance for a Team-Member view. This page is similar to that shown in FIG. 13, except that it does not include the access level column from the previous page.

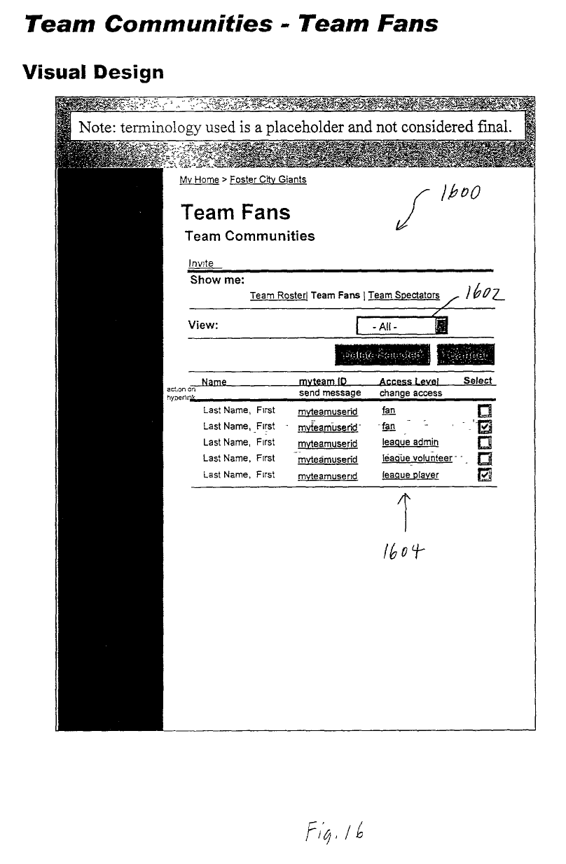

FIG. 15 shows a first representation 1500 of the Team Fans web page listing. This page lists the myteam.com members who have been granted Fan access by the Team Administrator. An “invite . . . ” hyperlink 1502 is shown tied to the myteam.com Communities invitation pages. A table is shown listing the Fans of this particular Team. A column 1504 includes the name of each Fan. Column 1506 shows the myteamuserid for each Fan. Each Fan can be selected via column 1508. The Delete Selected button 1510 can be used to delete the selected Fans from the table and from having Fan-level access to the Team pages. The Cancel button 1512 takes no action and returns the user to the page from which they came.

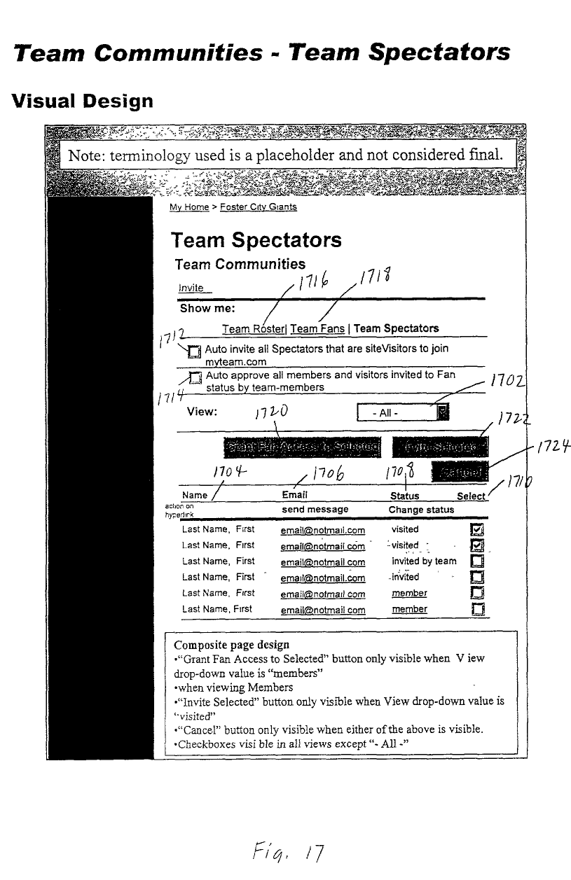

FIG. 16 shows an alternative representation 1600 of the Team Fans web page listing. This version additionally includes a View dropdown menu 1602, with the initial view being “all.” Dropdown menu values might include: All, fan, league administrator, league volunteers, and league players. Depending upon the value chosen, the various Fans displayed in the table will have that particular access level. This version also includes an additional column 1604 which shows the access level for each listed Team Fan. Access level values might include: fan, league administrator, league volunteer, and league player. Each of these values is hyperlinked to the Change Access page.

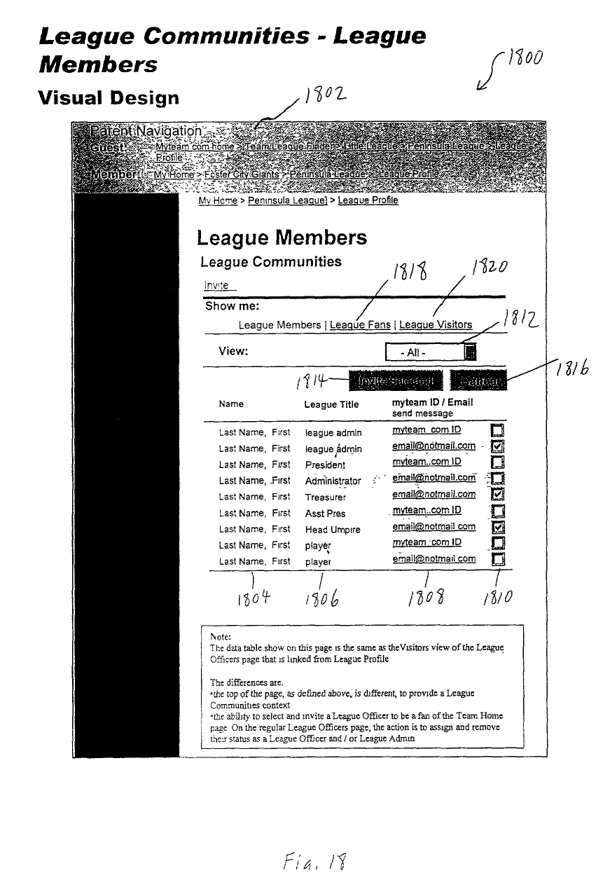

Referring now to FIG. 17, a representation 1700 of the Team Spectators (“Team Visitors”) web page listing is shown. Team Spectators are generally people who have requested, but have not yet been granted Team Fan (“Invited Guest”) status. The most common means by which people will appear on the Team Spectators web page is by finding the Team page through the Team/League Finder and clicking on a “Request Invitation” button. A “view” dropdown menu 1702 is shown, with an initial value of “all.” The dropdown values would include: all, visited, invited, and members. A table is shown which lists the Team Spectators according to the dropdown menu value selected, and the corresponding status of each Team Spectator. A first column 1704 shows the name of each Team Spectator. Column 1706 shows the email addresses. Column 1708 shows the status of each Team Spectator, with the table listings sorted by status in the order of: Visited, Invited by Team, Invited, and Member. Column 1710 provides for selection of the Team Spectators.

A checkbox 1712 is included to “Auto invite all Spectators that are site Visitors to join myteam.com.” If this box is enabled, the system will automatically send an invitation to all the site Visitors that “sign-in” to the Team Home page to join myteam.com. This invitation does not invite the Spectator to have Fan status, since this is a trusted relationship that should only be extended to people that the Team Administrator knows. Another checkbox 1714 is included to “Auto approve all members and visitors invited to Fan status by team members.” Since the trusted relationship exists, then auto approval can be performed. The checkboxes are generally visible in all Views except “all.”

Other hyperlinks and buttons are included. For instance, a team roster hyperlink 1716 provides a link to the Team Roster page. A Team Fans hyperlink 1718 provides a link to the Team Fans page. A “Grant Fan Access to Selected” button 1720 will only be made visible when the View dropdown value is “members.” This feature changes access to Fan status for those selected people. An “invite selected” button 1722 is only visible when the View dropdown value is “visited,” and if the checkbox to “Auto invite all spectators . . . ” is not enabled. This feature sends an invitation to become myteam.com members to the selected people. A “Cancel” button 1724 is only visible when either of the above buttons (1720, 1722) are visible. Clicking on this button takes no action and returns the user to the page from which they came.

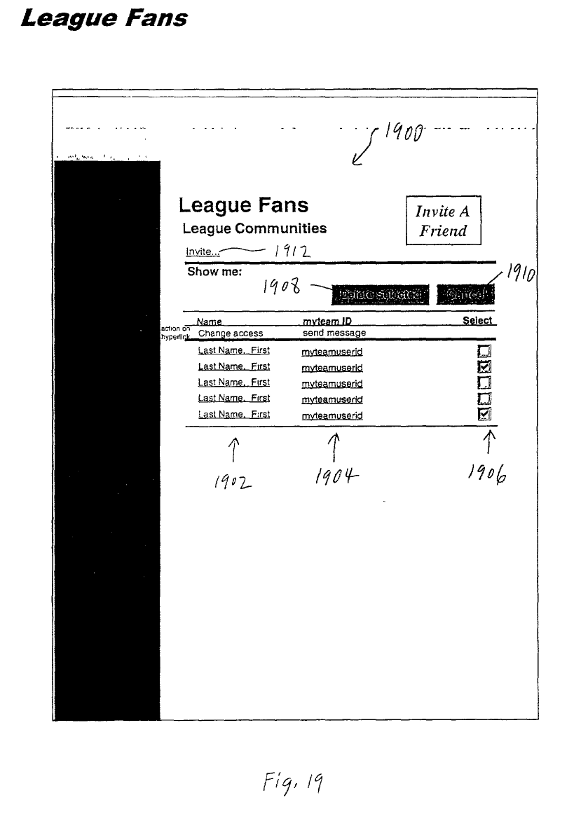

Referring now to FIG. 18, a representation 1800 of a League Members web page listing is shown. A league administrator will generally see a list of all League Members, and then they can be assigned to teams, and the like. The League Member list includes, but is not limited to, anybody that has signed the registration form, paid the registration fee, and has had their data entered by a league data processor. This page allows a League Administrator to go through and selectively invite any of the League Members to become myteam.com members. Batch invitations might also be sent out automatically to all Team or League members upon their being added, or be sent based upon such things as the person's title, and so forth.

A parent navigation bar 1802 is shown with example Guest click-through links, and example Member click-through links. A table is shown with League Members listed, and sorted with League Administrators at the top, and Players at the bottom. Column 1804 includes the League Member name. Column 1806 includes the League Title for each League Member, including for instance: League Administrator, President, Administrator, Treasurer, Assistant President, Head Umpire, and Player. Column 1808 include the myteam.com ID or email address for each League Member. Column 1810 allows selection of members. A View dropdown menu 1812 can be used to selectively limit the persons listed in the table. Dropdown values might include: all, Officers, Volunteers, or Players. An Invited Selected button 1814 allows invitations to be sent to the selected League Members. The Cancel button 1816 takes no action, and returns the user to the page from which they came. A League Fans hyperlink 1818 provides a link to the League Fans page. A League Visitors hyperlink 1820 provides a link to the League Visitors page.

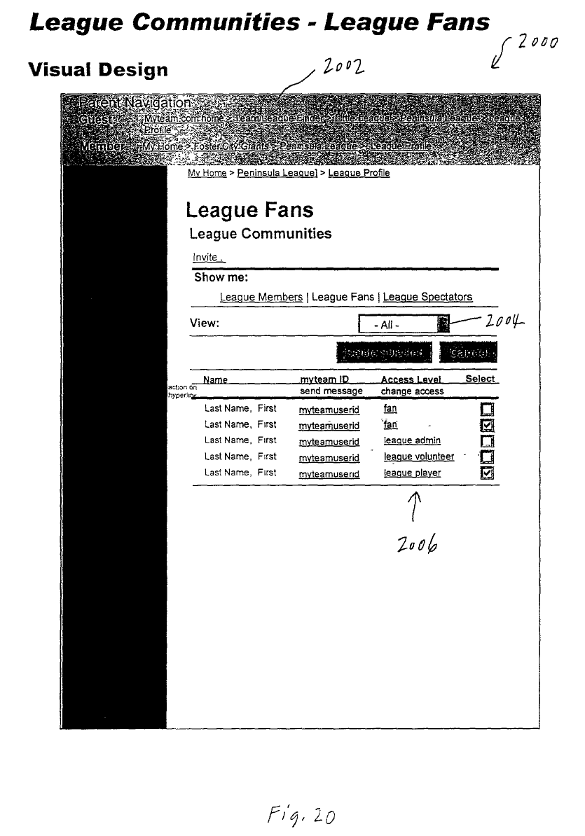

Referring now to FIG. 19, a first representative version 1900 of a League Fans web page is shown. This page displays all the myteam.com Members who have been granted Fan access to the League Home page. This page is similar to the Team Fans page, however, this page is viewable only by League Administrators. No League Participants can see this page, as there is more concern for security at this level.

A table is shown of the League Fans, sorted alphabetically by Name (last and/or first). Column 1902 shows the listed names of the League Fans. A hyperlink is associated with each name to the Change Access page to enable the individual's access level to be changed. If an individual's access is change to Participant, their name will then appear in League Members and will disappear from League Fans. Column 1904 shows the myteamuserid for each listed name. A hyperlink is associated with each myteamuserid which facilitates sending a message to that person. Column 1906 shows select/deselect checkboxes for each listed name. The Delete Selected Button 1908 will remove the selected individuals removed from the table. The Cancel button 1910 takes no action and returns the user to the page from which they came. The “invite . . . ” hyperlink 1912 links to an invitations page, as populated by My Communities invitations.

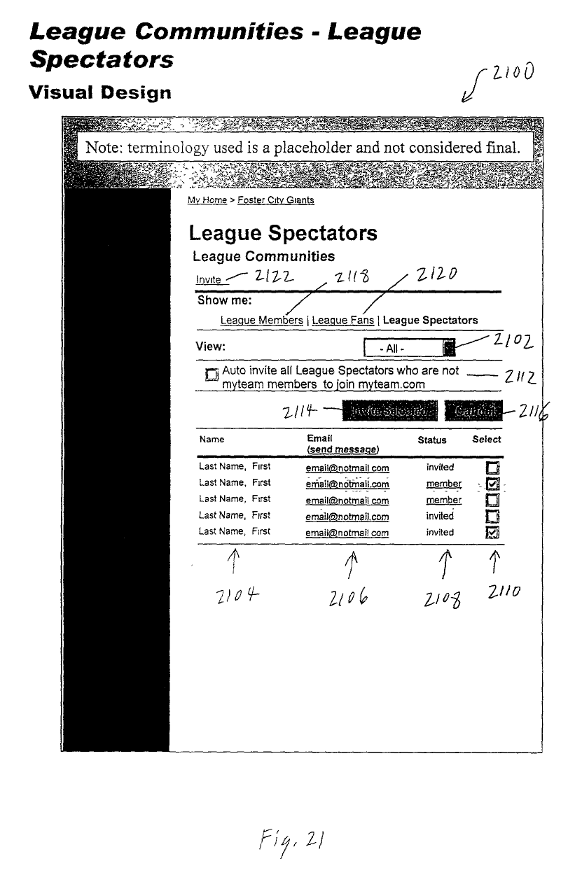

Referring now to FIG. 20, an alternative version 2000 of the League Fans web page is shown. This page is similar to the one shown in FIG. 19. A parent navigation bar 2002 is shown across the top, and includes Guest and Member hyperlinks. Also in this version, a View dropdown menu 2004 allows the selection of only individuals with a specific access level to be viewed. Access levels might include: fan, league administrator, league volunteer, or league player.

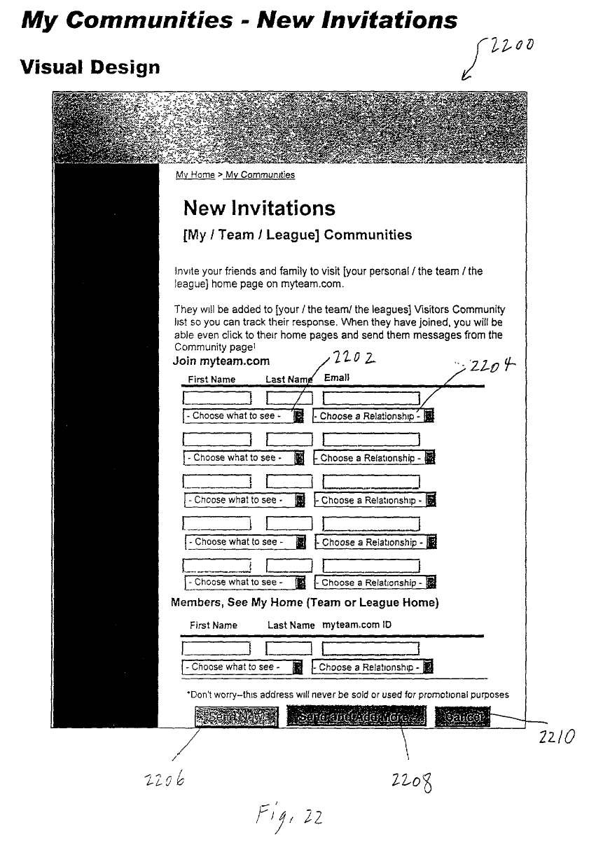

Referring now to FIG. 21, an example representation 2100 is shown of League Spectators web page listing. League Spectators are generally people who have not been granted any special access, but have requested it. If a League Administrator has sent out an invitation to a Spectator, then this page would provide the status of the invited who have not yet accepted such invitations.

This page lists all of the site Visitors and myteam.com Members who have found this League page using the Team/League finder, and have clicked on a “Request Invitation” button that appears on the League home page in that context. A View dropdown menu 2102 is shown with an initial value of “all.” Example dropdown values would include: all, visited, invited, or member. A table of League Spectators is shown, and the list includes names sorted according to their status, and limited by the dropdown menu choice. Column 2104 shows the list of League Spectator names. Column 2106 shows the email address for each listed Spectator, with a hyperlink associated with the name for send the Spectator a message through the Message Center. Column 2108 shows the status of the listed Spectator, including status value including: visited, invited, or member. Members have a hyperlink through the status display enabling the League Administrator to click-through to the Change Access Level page for the selected individual and change their access level to a Participant or Owner (Administrator). Column 2110 provides a checkbox for selecting various Spectators. A checkbox 2112 is provided to “Auto invite all league spectators who are not myteam.com members to join myteam.com.” The Invite Selected button 2114 is only visible when the View dropdown value is “visited” and if the “Auto invite . . . ” checkbox is not enabled. This button sends an invitation to the selected person to become myteam.com members, but does not grant them Invited Guest access. A “Grant Fan access to Selected” button (not shown) is visible only when the View dropdown value is “member.” This button changes the access to Fan status for those selected people. Once granted Fan status, the selected individuals will appear on the League Fans webpage and will no longer appear on the League Spectators webpage. The Cancel button 2116 is visible only when either the “Grant Fan . . . ” or “Invited Selected” button are visible. This button takes no action, and returns the user to the page from which that came. The League Members hyperlink 2118, and the League Fans hyperlink 2220 each link to those respective web pages.

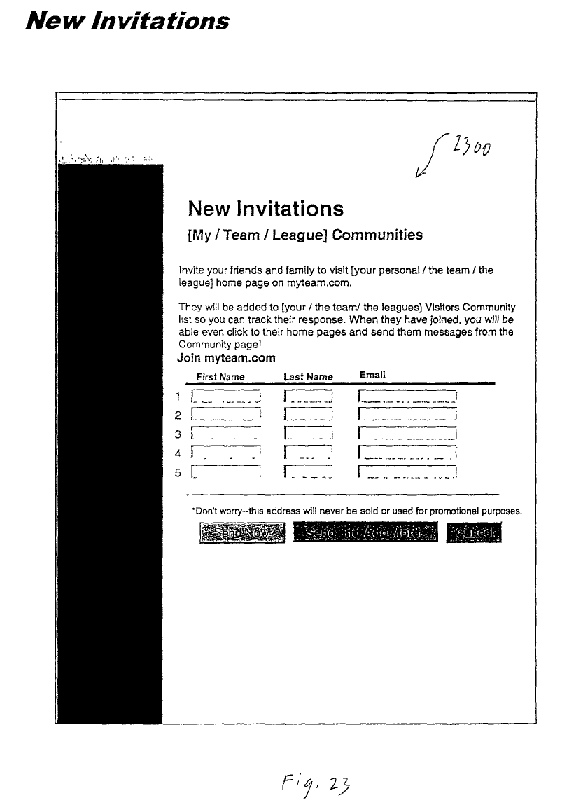

FIG. 22 shows a first representative version 2200 of a New Invitations web page as would be accessed from an individual's My Home page. A first table on the page allows invitations to be sent for joining myteam.com. A second table allows a Member to invite friends and family whom are already Members to visit the home page of themselves, their team, or their league (i.e. My Home, Team Home, and League Home pages) on myteam.com. The invited persons will be added to the respective Visitor's Community list on the personal, team, or league pages. When the invitees have joined myteam.com their name will be added to the respective Community page. For each name in the “Join myteam.com” table, a first pulldown menu 2202 allows the invitor to chose what the invitee is allowed to see. Example pulldown values for My Communities include: My Home, My Home & Team1 Home, My Home & Team2 Home, and so forth. A second pulldown menu 2204 allows the relationship between the invitor and the invitee to be specified. Example pulldown values for My Communities include: Friend, Parent, Relative, and Family Friend. Example pulldown values for Team Communities include: Team-member, Friend, Parent, Relative, or Family Friend. This provides the Administrator with a quick reference as to the trustworthiness of this extended invitation, as the Administrator will be required to approve the various invitations. A “Send Now” button 2206 submits the entered persons and returns the user to the page from which they came, with new persons added to the table listing on that page. The “Send and Add More” button 2208 submits the entered persons and returns the user to the invitations page to add more persons. The “Cancel” button 2210 takes no action and returns the user to the page from which they came.

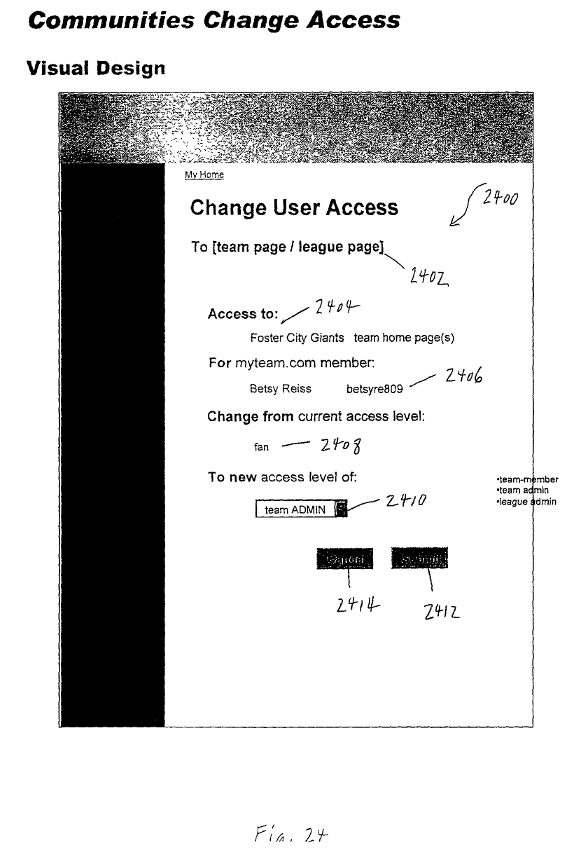

FIG. 23 shows an alternative representation 2300 of the New Invitations web page listing. This is a simplified version of the page shown previously, in that only a single table is used, and no pulldown menus are provided. Instead, the invitor enters the name and email address of the person to be invited to join the myteam.com website. The invitations are thereafter sent out via buttons similar to those described above and include Invited Guest access to the My Home, Team Home or League Home page from which this page was accessed.

Referring now to FIG. 24, a first version 2400 of a Change User Access page is shown. This page is typically used by an Administrator to facilitate an access change for a particular user. This page, or another page, such as the edit version of information for an individual, would be accessed by first selecting the name of the individual. The type of page (i.e. team page or league page) is displayed in area 2402. The “Access to:” information is displayed in area 2404. The “For” information 2406 shows the myteam.com member name and myteamuserid. The “Change from” information 2408 indicates the current access level of the user. The “To new access level of” information 2410 includes a dropdown menu of access level values that can be assigned. Such values might include: Team Administrator, Team Participant, Team Fan, and so forth. The “submit” button 2412 invokes the change request. The “Cancel” button 2414 takes no action, and returns the user to the page from which they originated.

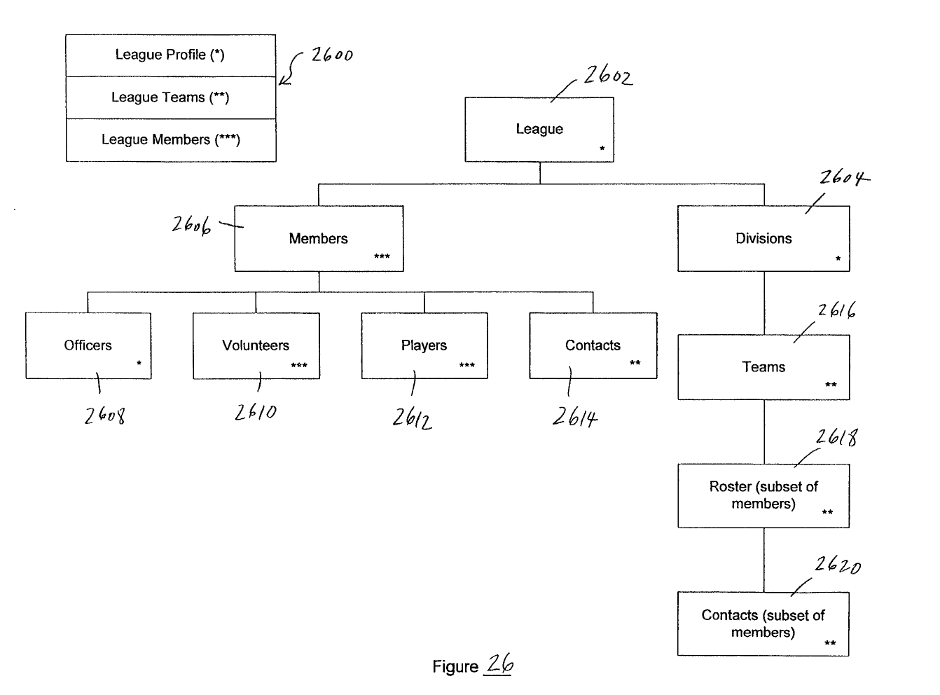

FIG. 25 shows a representative version 2500 of a Request for a Change of Access page. This page would typically be used by an individual wishing to change their access capabilities (i.e. to a higher level) for certain pages. The request would then be sent to the appropriate Administrator for approval and granting of any new access. The “Access to:” information 2502 indicates what page(s) are being accessed. The “Change From” information 2504 indicates the current access level of this particular user. The “To New” access level includes a dropdown menu 2506 for specifying what access is desired (i.e. Team Administrator, League Administrator, or Team-member). A “submit” button 2508 again sends the change request information for processing, and the “Cancel” button 2510 again takes no action, and returns the user to the page from which the user originated.

### Section 2—League Tools

The league tools interface provides the user access to detailed information about a league, its structure, and its members. The information to be managed is arranged in a representative hierarchy as described below.

The first branch of the hierarchy manages the individuals associated with the league. These individuals are categorized into groups based upon their role in the league. The interface provides access to four groups: Officers, Volunteers, Players, and Contacts. The other branch of data managed for a league is related to the organization within the league. For the purposes of this interface, a league is organized into divisions. Each division, in turn, has a number of teams. The conceptual hierarchy could be overlapped, with the first branch to partitioning down to each team's roster, and the contacts within that roster.

Referring now to FIG. 26, three sidebar items 2600 are shown which provide access to this information. The League Profile item provides access to league contact information, league division information, and the list of league officers. The League Teams item provides access to the teams in the league and their rosters and contacts. The League Members item provides access to the players and volunteers in the league. As shown in the block diagram, the hierarchy branches from the League 2602 down to Divisions 2604 and Members 2606. The Members include Officers 2608, Volunteers 2610, Players 2612, and Contacts 2614. The Divisions block 2604 branches to include Teams 2616, Roster (subset of Members) 2618, and Contacts (subset of Members) 2620. The League Profile sidebar item is associated with the League 2602, Officers 2608, and Divisions 2604 blocks (as indicated by the single asterisk). The League Teams sidebar item is associated with the Contacts 2614, Teams 2616, Roster 2618, and Contacts 2620 blocks (as indicated by the double asterisk). The League Member sidebar items are associated with the Volunteers 2610 and Members 2612 blocks (as indicated by the triple asterisk).

Note that the Divisions aspect might also be incorporated differently, as needed to support certain league/association configurations. For instance, in Pop Warner, AAU, tournament play, and the like, teams that play one another do not necessarily all reside within the same league. As such, the underlying database structure would allow for less rigid associations of a team with a particular division, or league.

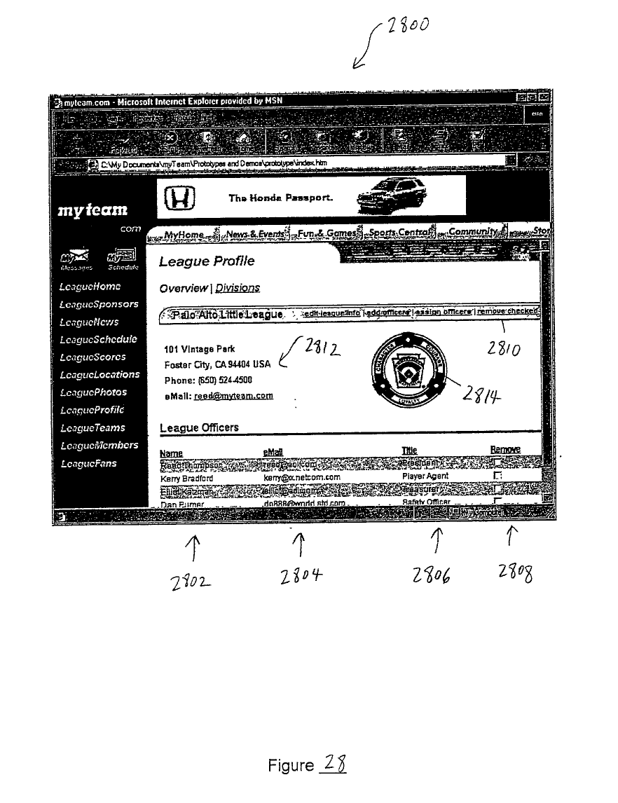

The League profile sidebar item provides access to data that tends to be set up once at the beginning of a season. This is generally the “high-level” information about the league. This high-level information includes General League Data, League Officers, and League Divisions. General League Data includes such items as league name, location (state, zip), primary contact person, and national affiliation (if any). League Officers usually consist of a President, Treasurer, Secretary, etc. League Divisions are used to manage sets of similar teams (i.e. age, sport) that play one another and compete in standings. FIG. 27 identifies eight possible screens (or pages) that might be used to comprise this section. The Overview page 2700 provides contact and officer information. Page 2702 provides for editing league information. Officers (i.e. single or multiple) can be added to the League via 2704. The Officers can alternatively be assigned from a list of existing League volunteers via 2706. A list of Divisions is available for viewing via 2708, and the divisions can be edited, or new divisions can be added, via 2710. The blocks with dotted lines represent jumps into other sections of the web site, so they are generally not considered to be part of this current area (or hierarchy). Volunteer Details 2712 is associated with the League Members area, and Team Info & Roster 2714 is associated with the League Teams area, both described above. Block 2716 provides the ability to list teams with a division selector. Block 2718 provides the ability add new teams (one at a time). Several pages also have shared implementations. Add Officers 2704 shares an implementation with Add Players and Add Volunteers. Assign Officers 2706 shares an implementation with Assign Players and Assign Volunteers.

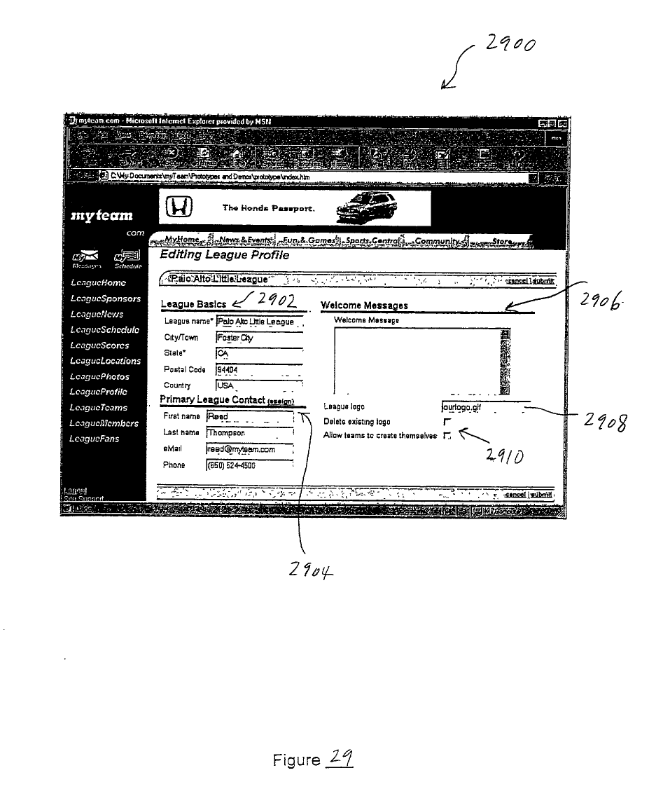

Referring now to FIG. 28, certain representative elements are shown comprising a League Profile Overview web page (or screen shot) 2800. This screen provides read access to two sets of information: basic league contact information, and the list of league officers. This screen also provides links or actions to access the divisional hierarchy, edit all general league data, and manage the list of league officers. The name of the officer is provided in column 2802, with the officers listed in alphabetical order by last name. The email address of each officer is provided in column 2804. Both the name and email addresses can have hyperlinks for messages to be sent to that person, and/or information retrieved about that person. Column 2808 shows a checkbox to remove an officer.

This page is available to all visitors, but is editable only by league administrators.

There are two types of data groups available on this page: League Info and League Officers. The types of viewers of the page include: Anonymous Visitor (AV), Invited Guest (IG), Participant (P), and Administrator (A). The information can be available for read, write, or none access based upon the type of user. In this instance, the Administrator can write League Info and League officer data. Participants can read both types of data. AV and IG can only read League Info. Data to which the user does not have read rights should not be displayed to that user. Therefore, the page is dynamic. If there is no access to League Info., then that data is not displayed. If there is no access to League Officers, then that table is not displayed.

Access to the actions (i.e. hyperlinks shown as edit league info, add officers, assign officers, and remove checked) as shown in box 2810, are generally available to users with write access. All visitors to a page see the contact information. The only difference between read-users and write-users is that write-users can see the “Remove” checkbox in column 2808. League address and contact information is displayed in 2812, along with a league logo 2814 (if available). This information is accessed directly from a league's record in the website's league database.

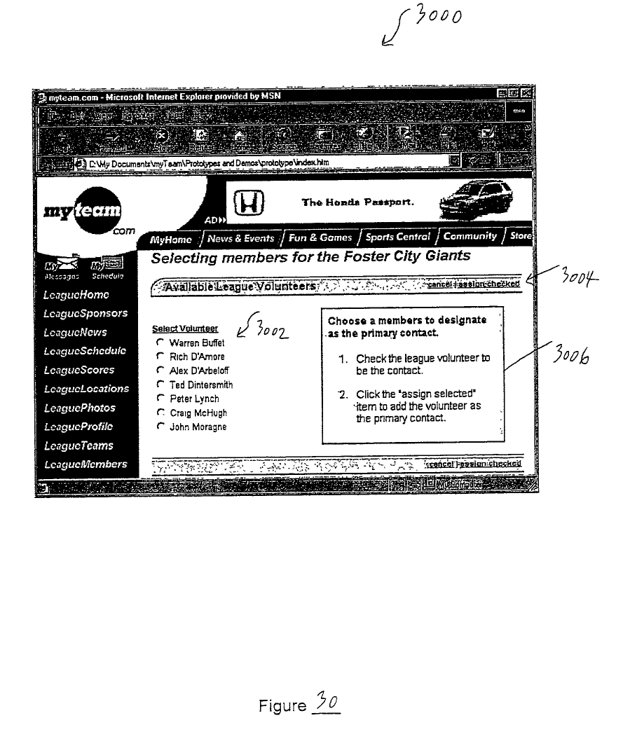

Referring now to FIG. 29, certain representative elements are shown which comprise a web page 2900 for editing the League Profile. A similar page is used to add a league to the website. This page generally permits the user to edit the data associated with the league itself (as opposed to data that might be embedded more so within the league's hierarchy of information). The League Basics are entered in the fields shown by 2902. Primary league contact information is entered in the fields of 2904. A link (“assign”) is included that allows the user to select a primary contact from a list of existing league volunteers. This link leads to the “Choose Contact” screen, described below.

Welcome messages to the league can be entered via 2906. If a league logo exists, it will be displayed on the screen as indicated by the file in box 2908, which uploads the image, and overwrites any old images. One of the checkboxes 2910 is shown for “Delete existing logo.” The message and logo allow the league to customize their home page with their league logo and a short message welcoming the people to the league site. The message is a text-only message entered into the profile and is thereafter viewable only from the league home page. The logo can generally be restricted in size (i.e. 100K) for ease in uploading to the web page and subsequent downloading by viewers of the web page. Only one logo may be uploaded and dropped into the “league logo” slot. This logo is displayed at the top of the League Profile page, in addition to being displayed on the league home page.

Access to actions is standard in that actions are available only to users with write access to the page. This particular page is only available to league administrators. Another checkbox 2910 also shows the option to “Allow teams to create themselves.” This checkbox controls whether or not teams can be added in a “bottoms up” manner to a league. In the strict security model, all teams inside a league must be created by a league administrator. The league administrator thereby allows access requests or changes to be made. This checkbox overrides that control, so that anyone can create a team and “enter” it into the league. Among other advantages, this makes it easier for the coach to add teams into currently inactive leagues. The “allow teams” checkbox will not be displayed for certain leagues (i.e. Little League Baseball leagues, or others that do not provide this ability). For Little League Baseball, the security remains tight, therefore the “allows teams” setting is turned “off” for all Little League teams, and the checkbox control is not displayed for Little Leagues. This checkbox can be made not available for specific organizations that have a business relationship with the website and have requested the feature to be removed as such. For all other organizations, this checkbox is displayed and the “allow teams” setting is turned “on” by default. If teams are allowed to be added, an “add a team” action link will be available in the Team Finder when browsing the teams contained within a league.

All information on this particular page is stored in a single record, i.e. the league's main record. This includes primary contact fields (i.e. name, email, and phone). Although it is likely that the primary contact for the league will be listed in the individual table, making this a freeform field allows the Administrator to change this information independently. When the first league Administrator is assigned (or becomes active) on this league, his or her name and contact information is automatically copied into these three fields. As such, this critical information is filled in automatically (at least the first time).

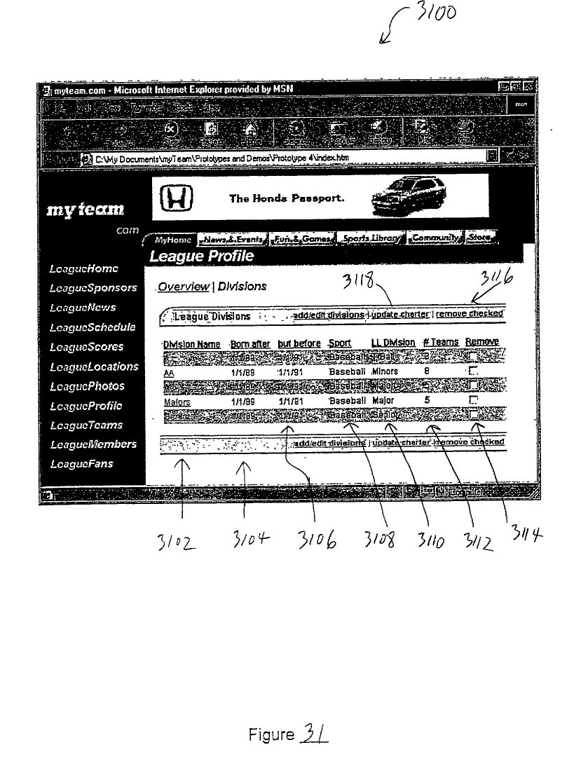

Referring now to FIG. 30, certain representative elements are shown which comprise a web page 3000 for choosing a contact. This screen is used from the team and league profile edit screens. The screen is generally used to select a volunteer as the primary contact for the team or league. For both the team and league, a list of available volunteers is displayed, in this instance “available league volunteers.” All available volunteers in this league are listed with radio buttons to the left of each name (for selection). Selections on this page are mutually exclusive as only one button can get selected and if a different button than the current one is selected, it replaces the prior one as the only selection. If the paging of the screen information kicks in, then prev/next or similar control buttons will appear on the screen. Clicking on the “submit checked” action link confirms the current selection as the primary contact. Clicking on the “cancel” action link will cancel the user's selection (if any) and return to the previous page. If the user chooses to submit without selecting a radio button, no error is displayed and the user is simply returned to the profile edit screen, and the contact information remains unchanged. A help text block 3006 is also shown, which directs the user to: 1) check the league volunteer, and 2) click the assign selected item to add the volunteer as the primary contact. In general, the title of the page should change to show the league name, if in the league context. The user selects (or checks) a volunteer and then invokes the assign checked action 3004 (which might also be labeled “choose selected”) to add the volunteer as the primary contact. Access to this page depends upon the context, i.e. whether the team or league profile information is being edited. Generally, however, the administrator has write access. All actions are accessible by individuals that can get to the page.

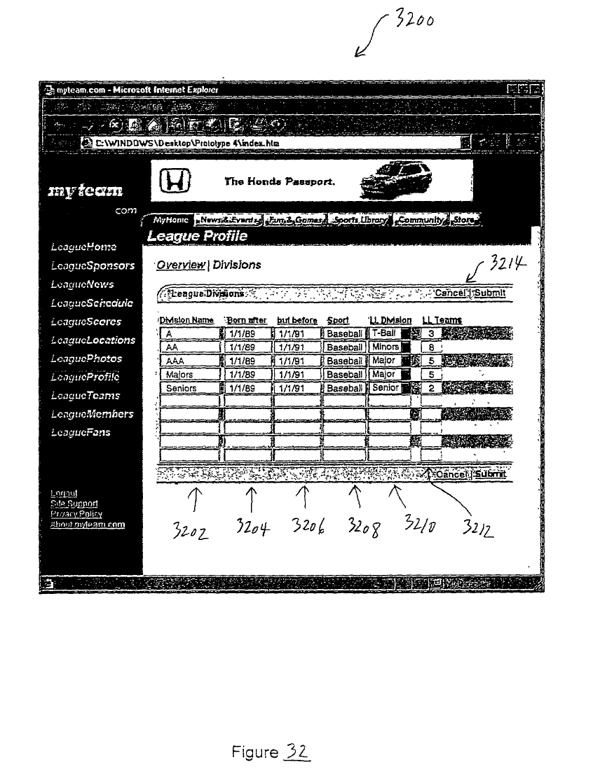

FIG. 31 shows certain representative elements that comprise a web page 3100 for allowing the user to view and delete League Profile Division information for the league (versus the Overview selection from FIG. 28). Note that this page (and others) might change significantly for certain specialized leagues, including for instance Little League Baseball. A League Divisions table is shown the Division name in column 3102. To determine the age that players in youth sports leagues can be and qualify to play on a team in a given division, the qualifying age range is determined from the “born after” date as shown in column 3104, and the “but before” date as shown in column 3106. The sport is shown in column 3108 and the Division is listed in column 3110. The number of teams in each division is shown in column 3112. Checkboxes 3114 can be used for removing any division.

The page may be read by the public, and may be edited only by league administrators. Access to actions, as shown in 3116, are available only to users with write access to the page (i.e. the Administrator). Certain columns might also be made to appear only to individuals with edit access to the page. Read only visibility might only show the Division name, born after, born before, and sport items. Little League Baseball might also warrant a separately viewable column for “LL Division.” The “Sport” column might also be hidden if the national organization with which this league is affiliated is associated with only one sport.

Most of the information can be databased (or stored) right on the division record. However, the number of teams must be calculated by query to see how many teams are in each division. Little League division information might be stored in a separate record.

The Update charter button (or link) 3118 is visible only to administrators of specialized leagues including Little League Baseball. This button links to a page that totals the number of teams in each type of “officially chartered” division and facilitates the updating of a league's charter to include new types of divisions not previously chartered. The button facilitates the syncing up of charter information with the teams listed in myteam.com. Once this charter information has been set or updated, it can be sent to Little League on a regularly updated (i.e. daily) or manual basis. This button can be made to warn the user before performing its operation, with a simple message box.

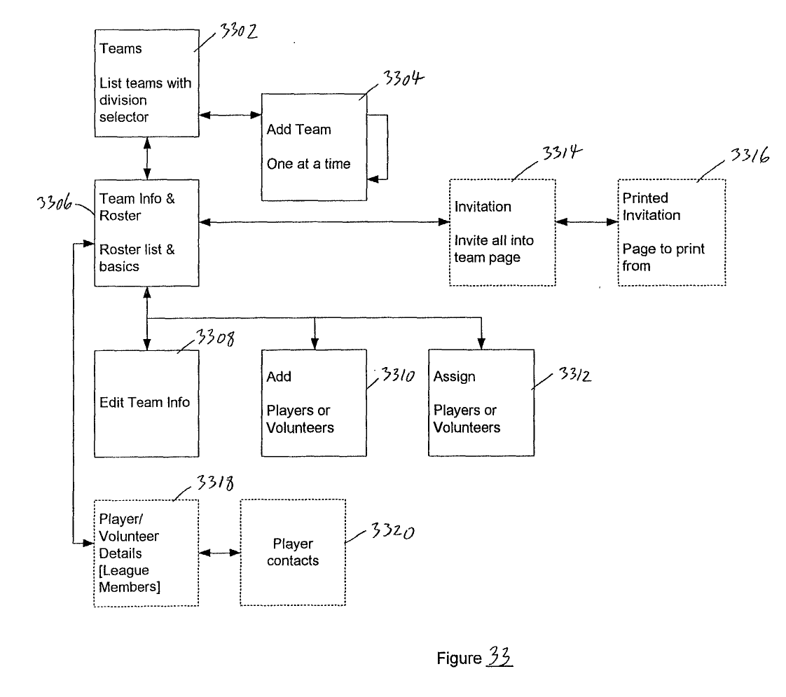

Referring now to FIG. 32, certain representative elements are shown which comprise a web page 3200, which allows the user to add, edit, and remove league divisions. The screen uses a “freeform” approach, which lets the user enter division data into edit boxes, which can be changed as needed. Skipped rows will not be processed or stored. Column 3202 provides edit boxes for the Division names. Columns 3204 and 3206 enable entry of birthdates to determine the youngest (born before) and oldest (born after) players that can qualify to play on teams in this division. Column 3208 provides a box for the sport associated with each division, and might also include a drop-down list from which to choose. Column 3210 (optional) provides a LL Division column that is only visible to LL administrators. This enables the type of division (minors, majors, etc) to be indicated for each division without such designation being required in the division's name. The LL Teams column 3212 is optional and allows entry/display of the number teams in that LL division.

This page is generally accessible only to league administrators. The page will implement this by checking for the “League Divisions” data group, and only permit access to users with at least “edit” access. Once the user gets to the page, all actions 3214 are accessible. Of course, since a “read” user cannot even get to this page, “read” users cannot utilize the shown actions. The LL Division column is displayed only if the league is a member of the LL organization. The Sport column is not displayed if the national organization is affiliated with only one sport. The control is filled with different values depending upon the national organization with which the league is affiliated.

Error messages are displayed for incorrect entries. In this multiple entry form, it becomes important that the information entered is not lost on errors. Display of the error page, and a “try again” link, brings the user back to the edit screen, with all existing entries intact (except that invalid data might be excluded). If all required field entries in a row for a current division are made empty, then upon submission an error dialog will appear warning the user that this will result in the division being deleted from the league, and will also delete all teams in that division and the relationship of the players and volunteers assigned to them. An “OK” button on the dialog will complete the submission and subsequent deletions. A “Cancel” button on the dialog will return the user to the page with the changes intact on the page but not submitted to the server for implementation.

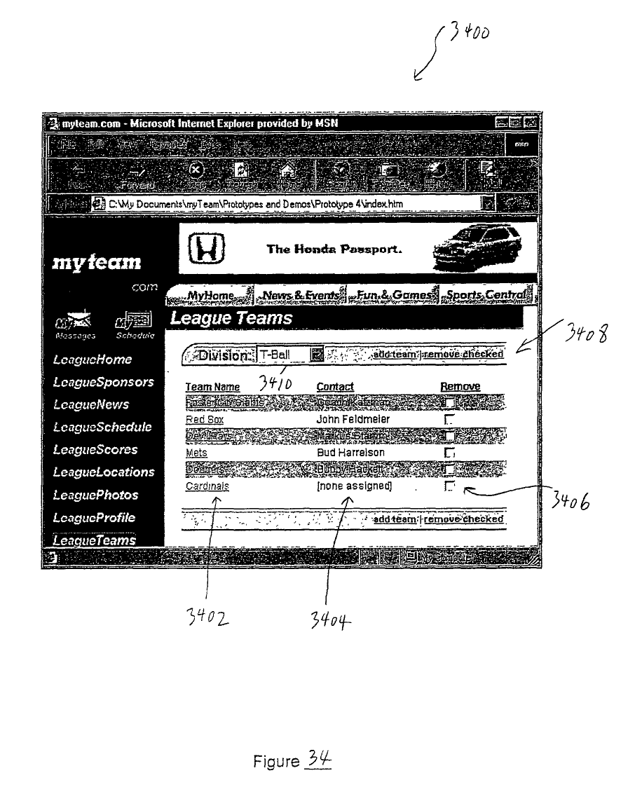

Referring now to FIG. 33, a block diagram 3300 is shown of the sidebar item League Teams which provides access to team information at the league level. This includes Lists of Teams, and Lists of Rosters. The Lists of Teams can be filtered by available division. The Lists of Rosters allows the user to add, delete, and modify the players and volunteers associated with each team. FIG. 33 shows six potential pages (or screens) that might comprise this sidebar item. The entry point is the Teams screen 3302, which provides a list of the teams with a division selector. The Add Team screen 3304 allows teams to be added, one at a time. The Team Info & Roster page 3306 provides roster lists and basic information. From this screen the user can Edit Team Info 3308, Add Players or Volunteers 3310, or Assign Players or Volunteers 3312 from the list of League Members. The dotted boxes for Invitations 3314 (Printed Invitations 3316), Player/Volunteer details 3318 and Player Contacts 3320 represent jumps into other sections of the myteam.com web site (and are not part of this sidebar section). Two of the screens also have a shared implementation. Add Officers (not shown) shares an implementation with Add Players and Add Volunteers. Assign Officers (not shown) shares an implementation with Assign Players and Assign Volunteers.

FIG. 34 shows certain representative elements that comprise the League Teams Main Page 3400. This page lists the teams in a league, as filtered by division. Regardless of how this page is reached, the League Teams sidebar item should become selected when this page is displayed. This would be the default situation if the user selected “League Teams” from the sidebar. However, the sidebar should become selected even if this page is reached by clicking on a division from the “League Profile” section.

The League Teams page shows the team name in column 3402. Clicking on the Team name will do one of two things. If the user is a League Administrator, they will then see the Team's Roster. If the user does not have League Administrator access, they will then see the Team's home page. The Team contact is shown in column 3404. A remove checkbox for each team is shown in column 3406. A pulldown menu 3410 is provided for selecting a specific division and permits the user to select which list of teams is to be displayed in the main table of the page. The list of divisions from which to choose from is the list of all divisions associated with the league. The list is displayed in the order of their listing in the Edit Divisions page, FIG. 32. The default division may be specified by the caller of the page (via a URL parameter). This provides the ability for a user to click on a division from the League Divisions page to arrive at the current page. If not default division is specified, then the first division listed is selected. Actions can be accessed via links 3408. “Add team” goes to an edit Team Info page for the purpose of adding a Team into the currently selected division. All columns (except Remove) are visible to readers. The remove column is shown only to editors (i.e. users with write access). The actions 3408 are available only to those with write access to the page.

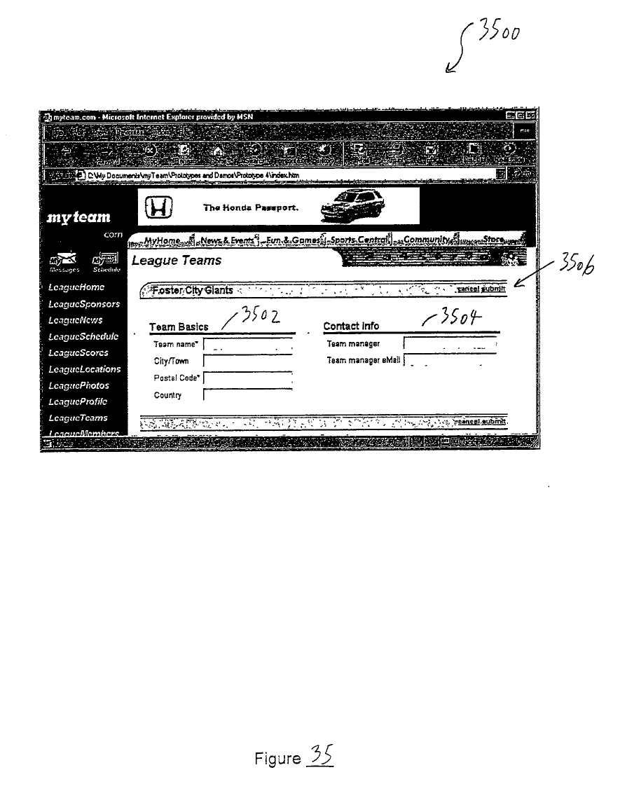

Referring now to FIG. 35, certain representative elements are shown comprising a web page 3500 that allows a team to be edited. The page allows for editing of basic team information, for the purposes of adding a new team, or editing an existing team. This page can be accessed from the Add Team selection on the League Teams page; from the Edit Team Info action on the Team Roster and Info page; or from the Add a Team action in the Team Finder. The page receives state information (preferably on the URL) indicating: what team is being edited; or if a new team is being created, and the division in which to create the team. The title can be changed to reflect how the user arrived at the page. The page is accessible only to coaches, designated team administrators, or league administrators. The access level is checked against the entity (team or league) through which the user entered the page. Column 3502 shows the entry fields for the team information. The contact information is entered in fields 3504. Actions 3506 are available only to page editors.

A “choose a contact” link (not shown) can be provided to permit the user to select an existing league volunteer to use as the primary team contact. The team contact has, by default, administrative access to the Team pages. The interface uses the “Assign Volunteers” page to select a contact for use. If this operation is performed at the “team” level, then the list of available volunteers would be the team's volunteers. If this operation is performed at the “league” level, then the list of available volunteers would be all league volunteers. The result of the selection creates an association between the individual and the team and copies the selected contact's name and email information into the team's “primary contact” information fields. If the name and email for a team contact are manually entered, the individual is added to the team as a volunteer with administrative access and they are also added to the league membership as a volunteer.

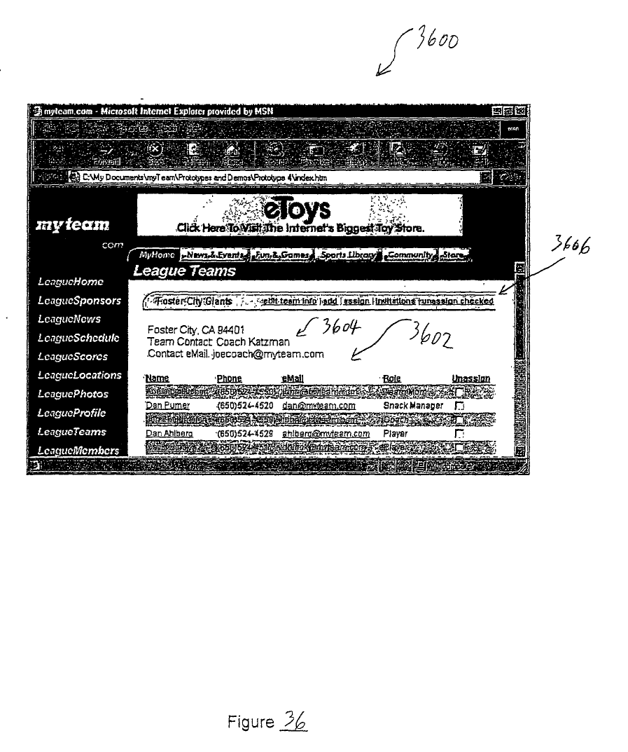

FIG. 36 shows certain representative elements comprising a web page 3600 for displaying the roster (i.e. players and volunteers) of a team. This page is accessed from various places in the user interface: the League sidebar (i.e. League Teams, after clicking on a team); the Team sidebar (Team Roster); and from clicking on the Team Info capsule from the Team Home page. The page title is dynamic based upon how the user arrived on the page. The roster table includes the name, phone, email, and role of each listed individual. The roster table is actually the sum of records from two queries. The volunteers are retrieved from the contact table by asking for all roles associated with the team. Each role association includes an association type (enumerated) and a title (role) that is either entered as freeform text or is automatically entered based on the context of how the individual was added to the team. Display of the role column on the screen uses the title if available, and the association type if not. The players are listed in the player table and are extracted for the team. In either case, the name, phone, and email are taken from the related individual record for each person. An “unassign” checkbox is also provided for each person. General team and contact information is shown as 3604. User actions are shown as 3606.

The page generally contains two data groups: Team Info and Team Roster. Access to Team Info data is “read” for AV, IG, and P type users, and access to Team Roster data is “none” for AV and IG type users, and “read” for P users. Administrators have full write access for both types of data. Access to actions is based upon both the data group and the access level of the user. The column data is also varied depending upon the user access level. The name column is visible to anyone with read access, but has an underlined link only if the user has write access to the page. The “unassign” column appears only to individuals with edit access to the Roster information. When a player or volunteer is selected in the “Unassign” column and the “Unassign checked” action link is selected, the individual is “unassigned” off the team roster and their security access to the team is removed in their individual record. They remain in the list of League Members and retain any security access to the League.

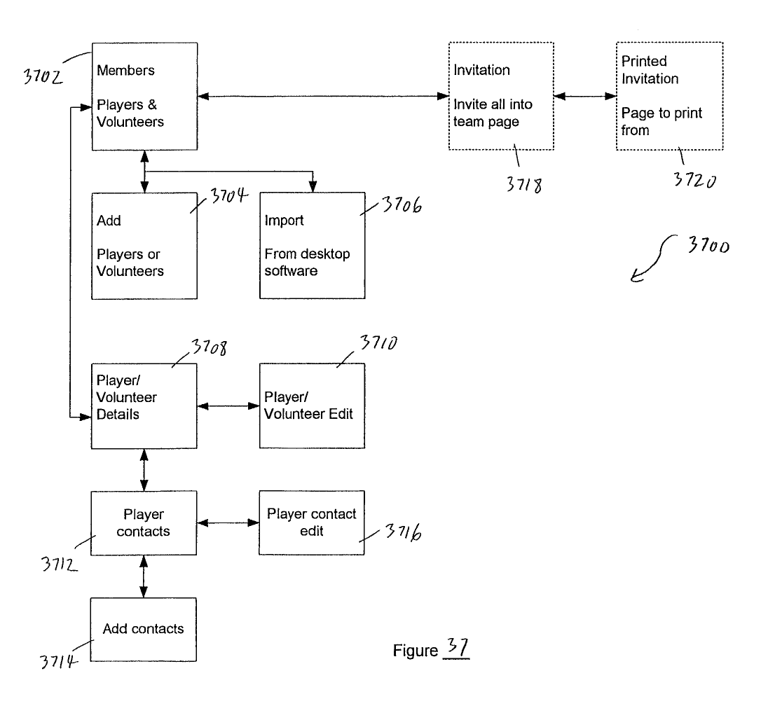

Referring now to FIG. 37, a block diagram is shown of certain representative elements 3700 comprising the League Members sidebar item. This sidebar item provides access to information about the people that make up the league, i.e. the players, volunteers, and officers. Since access has been provided to the officers in the League Profile, this section provides access to League Players, and League Volunteers. League Players provides for tracking players in the league, regardless of their affiliation with an individual team. League Volunteers provides for tracking the volunteers of the league (coaches and other individuals) that help run the league, regardless of their affiliation with an individual team. FIG. 37 identifies screens that might be used to comprise this sidebar item. The Member block 3702 provides the entry point for accessing information about Players & Volunteers. Block 3704 provides the ability to Add players or volunteers, whereas block 3706 allows information to be imported from desktop (or other) software. Block 3708 provides further Player/volunteer details (as desired), and such information can be edited via 3710. The Player Contacts block 3712 displays information for parents and emergency contacts for a Player. Block 3714 provides the addition of a Contact and/or Parent to a Player's information and block 3716 provides for editing a Contact's information. The Invitations 3718 and Printed Invitations 3720 boxes are shown with dotted lines to represent jumps into other sections of the web site.

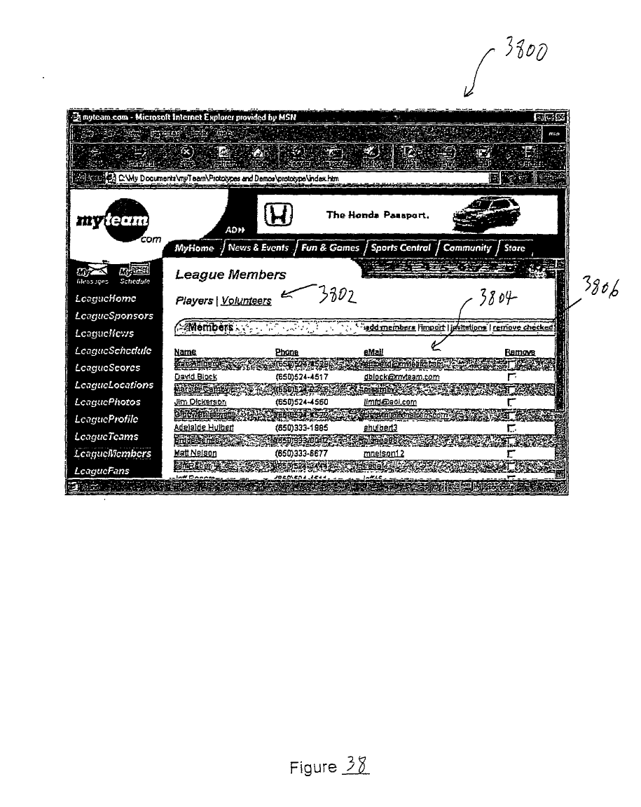

Referring now to FIG. 38, certain representative elements 3800 are shown comprising the League Member page with Players/volunteers shown thereon. By using the link 3802, the user can decide whether to view players or volunteers. In this instance “Players” has been selected. This page is reached through the League sidebar. On the volunteer side, all non-players (all individuals with a role association type not equal to ‘player’ or “contact”) are listed. On the player side, only the players are listed. The table 3804 shows the name, phone, and email of the listed players, along with a remove checkbox. A list of actions are shown as 3806.

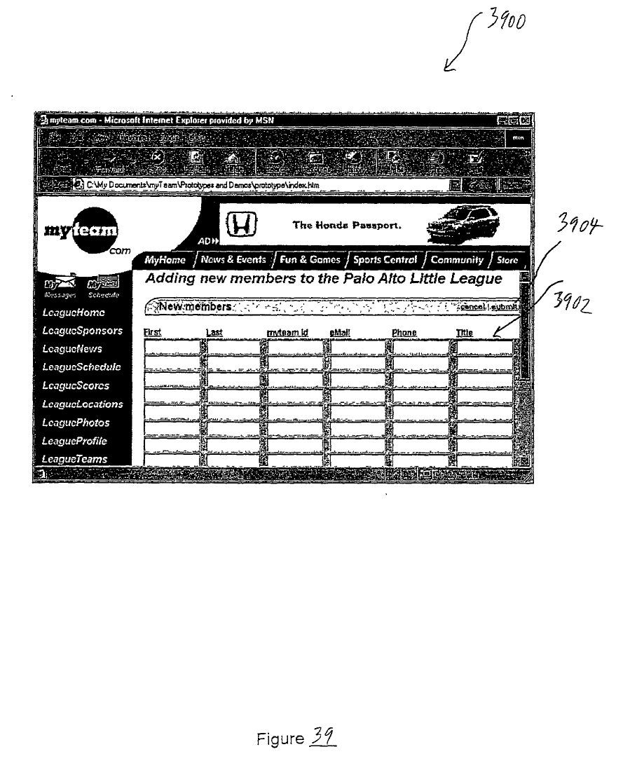

FIG. 39 shows certain representative elements 3900 comprising the screen used to add players, volunteers, or officers to the league. This particular page permits the user to add up to 15 players, volunteers, or officers to the league, all at once. Since all information about the league member cannot be entered on this multiple-entry screen, the user may later click on the member and edit that individual's information in order to fill in more details not captured on this screen. The title of the page will reflect the operation that the user is performing, i.e. Add Players, Add Volunteers, Add Officers, or Add Contacts (instead of “New members, as shown). A link might also be provided to allow the user to “submit and add more” if the form is filled up, and more individuals need to be added. Required fields might also be given a special designator, such as red labeling or the like. The table 3902 provides for entry of the first and last name, myteam-Id (Member-ID), email, phone, and title of the individual. Title may be a free-form entry field or may be a dropdown menu of pre-defined choices. The user action links 3904 allow the entries to be submitted or cancelled. For a Submit action, and for each member being added, database entries are created as follows: create and fill in an individual record with most fields; role association of the individual to the league; role association of the individual to the team (if being added to the team); role association of the individual to a player (if a contact being added to a Player); if a valid Member-ID is provided, set a security association to the league in the Member Account record that contains the Member-ID; if a valid Member-ID, set a security association to the team (if being added to the team) in the Member Account that contains the Member-ID; if no valid Member-ID is provided, create a Shell Account for the individual and set a security association to the league in that Shell Account, and a security association to the team (if being added to the team) in that Shell Account. It is intended that Invitations be automatically sent when an individual is added.

This page is generally available only to Team or League Administrators. The system implementing the site checks for the proper data group (depending upon whether the user is intending on adding players, volunteers, players to the Team or League, or Contacts to a Player). Access to this page is permitted only if the user has “write” access to the data group. There are generally no changes to the inner workings of the page based upon access level of the user. However, the title and some of the columns do change based upon whether the page is being used to add player, volunteers, officers, or contacts. Access to actions is all standard, in that actions are available only to users with “write” access to the page.

Most of the information on this page (except for the “title”) should be stored in a single record, namely the individual record. The title field is actually stored in the role association. The Member-ID is stored in the Member Account record as a form of the user's account number. When this page operates at the “team” level (i.e. when a player or volunteer is being added to a team), a role association is created to both the team and the league. This type of association with the league matches the type of the association with the team (player or volunteer).

For any individual being added with a valid Member-ID, the submit operation has security implications. From this screen, new individuals with valid Member-IDs are always added as Participants to the target entity. In addition, if an individual is being added to a Team, then a Participant-level League relationship is also automatically created. For example, if a volunteer is being added to a team, and a valid Member-ID is provided for that new volunteer, then the new individual should be given Participant-level access to the team and to the League. For individuals being added without a valid Member-ID, a Shell Account is created for each Individual and which contains the Participant-level relationships, but in an in-active state until an Invitation to the League (or Team) is accepted and the Shell Account is turned into a Member Account.

It is intended for there to also be a similar add page, which performs the same as 3900 but which only provides for one individual to be added at a time. Such page would allow input of additional fields of information related to the individual and would provide an action link that would submit the current individual and clear the page for the entry of the next individual. If a player is being added, this page would also display fields to add 2 parents/guardians as contacts.

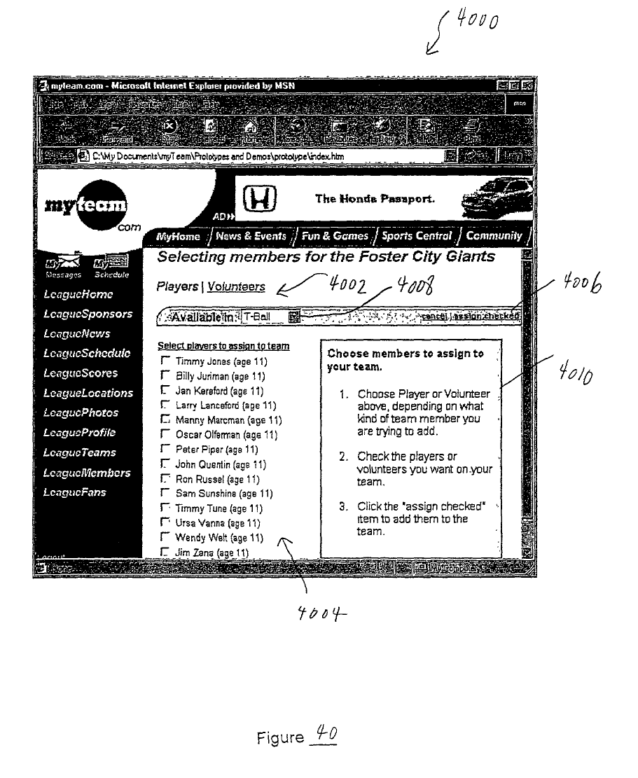

Referring now to FIG. 40, certain representative elements are shown of a web page 4000 for assigning players or volunteers to teams, or to permit the designation of officers in the league. In this instance, the “Player” view of league members on this page has been selected from link 4002. A list of players 4004 are shown, which can be selected (via the checkboxes) and assigned to the team indicated above. The players listed are those whose birthdate qualifies them to play on teams in the Division selected in the dropdown menu 4008 and who are not currently assigned to a team. The selection choice in the dropdown menu of “All” will show all players in the league who are not currently assigned to a team. This “All” view enables the age restriction to be “over-ridden” and players assigned to a team that would not otherwise qualify due to the age restrictions for the division the team is in. The user actions are shown as 4006. A help box 4010 provides instructional text on using the page.

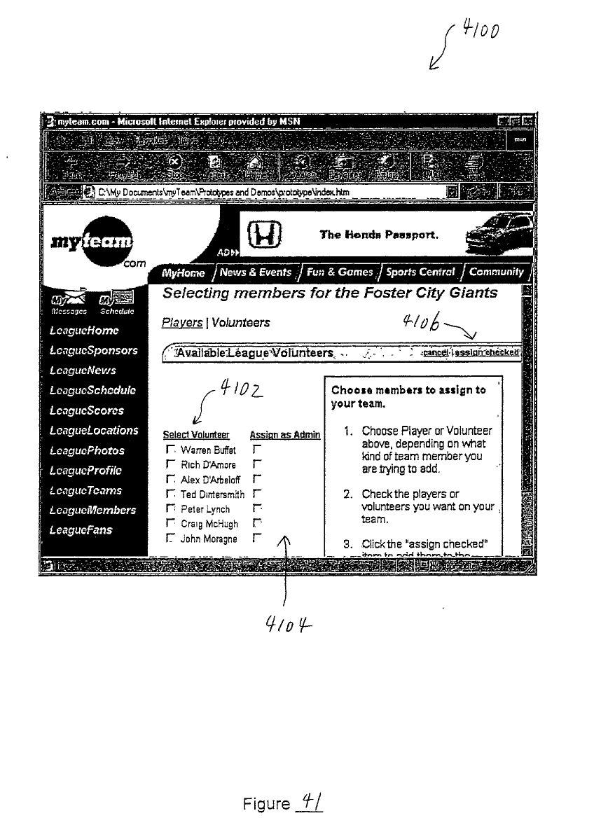

FIG. 41 shows certain representative elements of a web page 4100 for assigning volunteers to a team (as similar to FIG. 40). In this instance, the list of volunteers 4102 can also assigned as an administrator via the checkboxes 4104. The possible user actions 4106 include assigning the checked individuals to their new roles.

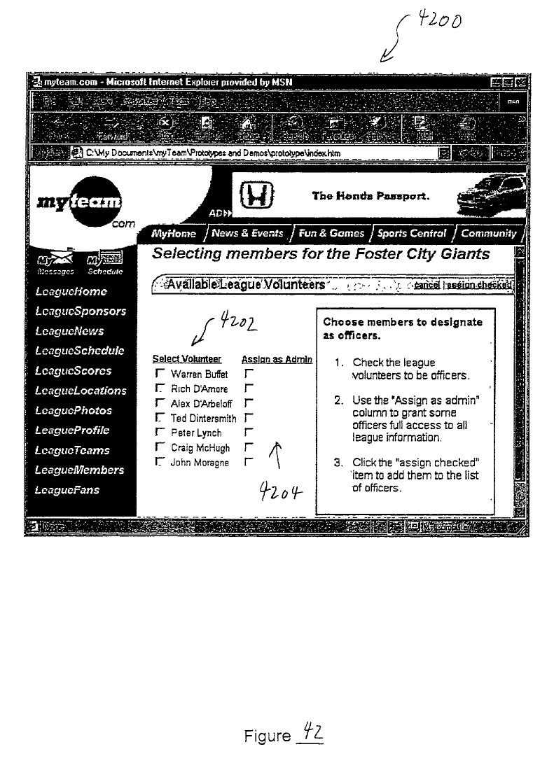

FIG. 42 again shows a similar set of representative elements comprising a web page 4200 for assigning officers to a league. In this instance, the list of league volunteers are those whom have not already been assigned as league officer or administrator. They can also be selected to be an administrator for the league via the checkboxes 4204. If only a name is checked, and not the “assign” checkbox, then the volunteer will be assigned as an officer accordingly, without being made an administrator.

The pages represented in FIGS. 40-42 are available only to league administrators when the page is accessed as part of a league entity. The pages are available only to team administrators when the page is accessed as part of a team entity. There are no changes to the inner workings of the page based upon access level. However, the title and “section switch” control (i.e. link 4002) do change based upon whether the page is being used to assign players, volunteers, or officers. Also, the “assign as admin.” column is displayed only in Volunteer or Officer mode. Since these pages can be invoked from a number of contexts, the behavior of the controls will change based upon the context.

These pages utilize the standard style-sheet for modal selection from a list. As a result, controls for paging through the list of qualifying individuals (such as previous/next or alphabetical selection) may show up if more than a predetermined number of names are available for display. The Division control appears in the “Assign Player” context. This control contains a list of all divisions in the league, with the last selection being “All.” The default selection is the division in which the team resides that is currently having players or volunteers assigned to it. If there is only one division (or none from the user's point of view), then this control is not displayed. If the division selection is changed, then the page is refreshed to reflect the newly selected division and the individuals who qualify them to participate on team in that division. Various explanatory text can be displayed (in context) to help the user through the process.

Assigning a member means that a role association and a security relationship is created between the individual and the team or league. The role association and security relationship is stored with the Member Account if the individual has a valid Member-ID and is stored with the Shell Account if the individual is not yet a Member. Unless the “assign as admin” checkbox is selected, the security relationship created is always at Participant-level access. If the “assign as admin” checkbox is selected, then the security relationship is admin-level access. If a player is assigned to a team, and that player has contacts listed, then the contact users should also be added with participant level security access to the team.

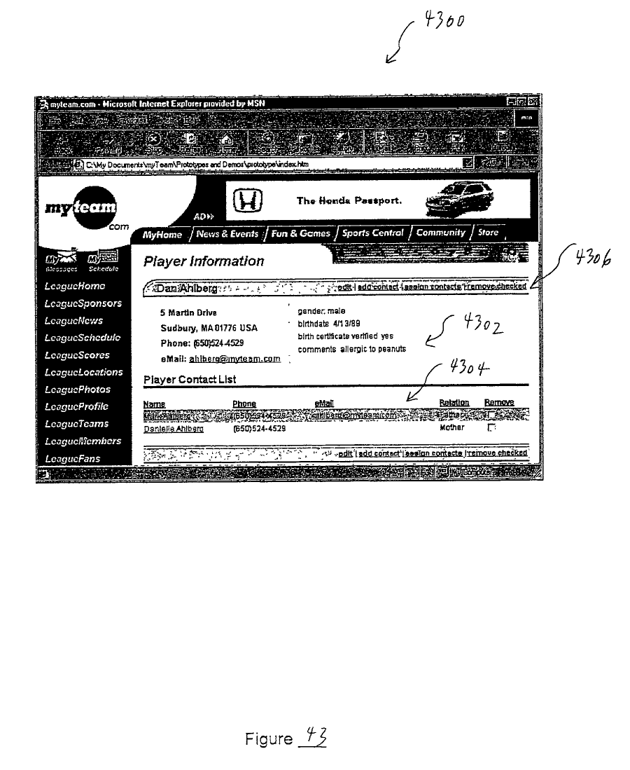

Referring now to FIG. 43, certain representative elements are shown comprising a web page 4300 for displaying a league member's detailed information in the “read” mode. If the user has edit access to the individual's record, then an edit button is displayed on the page. The page can be accessed from: the league profile screen (by clicking on an officer); the league member's screen (by clicking on a player or volunteer); the team roster (by clicking on a player or volunteer); or another individual's detail screen (by clicking on a contact). No cancel functionality is provided from this screen. It is intended for there to be a “back” button that would return the user to the previous screen. This page represents the “deepest” level of the pages through which a user can progress (in this example hierarchy).

The player information 4302 is shown with various fields, including name, address, email, gender, birthdate, and comments (i.e. allergic reactions). The player contact list 4304 displays parents and emergency contacts and includes the name, phone number, email, and relation to the player of each listed individual. A remove checkbox is provided with each contact name. The user actions 4306 allow for further manipulation of the displayed Player information (including edit, add contact, assign contacts, or removed checked). Clicking on a contact's name 4308 will display an edit page for the information for the contact individual.

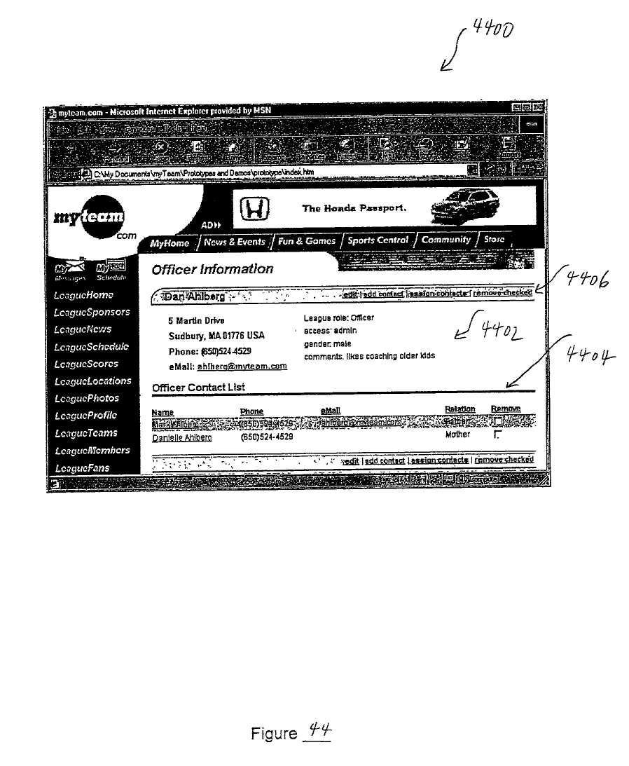

FIG. 44 shows certain representative elements of a web page 4400 for displaying (or changing) Officer information. The Officer information fields are displayed in 4402. It is not intended for there to be an officer contact list 4404 as this is only provided for players, not league officers and volunteers. The user actions 4406 allow for further manipulation of the displayed data (same as above).

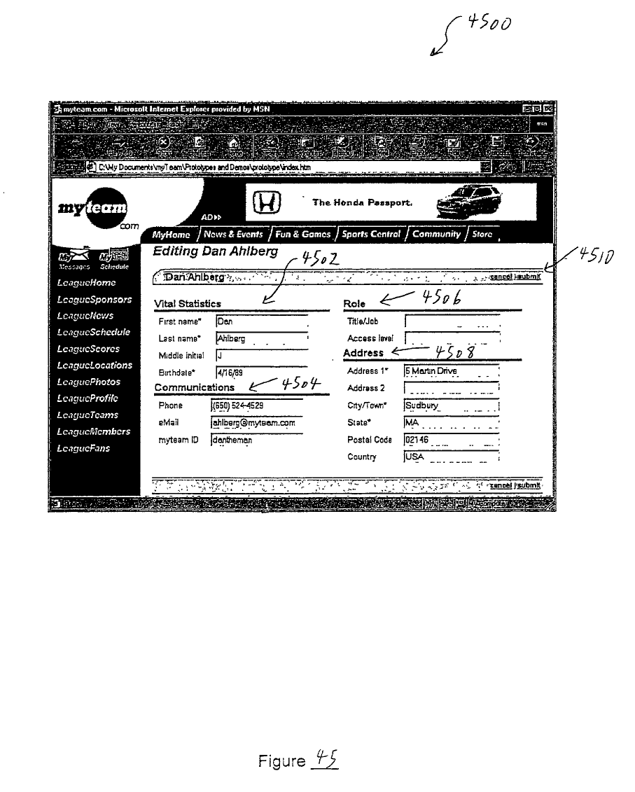

FIG. 45 shows certain representative elements of a web page 4500, which permits editing of an existing individual in the league and/or team. A similar page provides the means to add an individual to the league and/or team. The page is accessed from the individual's “read” view. If the user has write access to the individual's record, then an edit link on the page brings the user to this page. The editing layout includes the vital statistics 4502 for the individual. In general, the birthdate will not be shown for volunteers or officers. Certain required fields would include first name and last name. The birthdate would be required for players, and a phone number would be required for contacts. Communications information is shown in 4504, which includes the person's myteam-id. The individual's role (including title/job, and access level) are shown in 4506. The access level might include a dropdown menu of valid choices for this individual. The address is shown in 4508 with standard fields. The context of the access level setting is intended to be labeled to be either team or league as the individual's access may be different to a team as it is to the league the team is in.

When the myteam-id (Member-ID) is set or changed on a player or volunteer, then a security relationship is created between the named Member-ID and the entities (Teams and Leagues) to which the individual is connected. If a Member-ID is being replaced, then the individual's security relationships are transferred to the Member Account for the Member-ID. For volunteers or officers, the access level set for the named Member-ID matches the access level control on the screen (by default all volunteers and officers are given Participant level access). For players, the access level is always set to Participant automatically.

When using this screen to add a contact to a player, the role association is set between the two individuals as appropriate (either Contact or Parent). Once the role association is set, if the contact is a parent, they are given Participant access to the Team and its League that the Player is a Participant in. If the contact is not a parent, they are given Fan access to the Team and its League that the Player is a Participant in. When an individual's security relationships are set up with a team or a league, the security relationships of the individual's contacts should also be set up. When the individual's security relationship is severed, then those contact's relationships should also be severed.

### Section 3—Generalized Computer System Embodiment

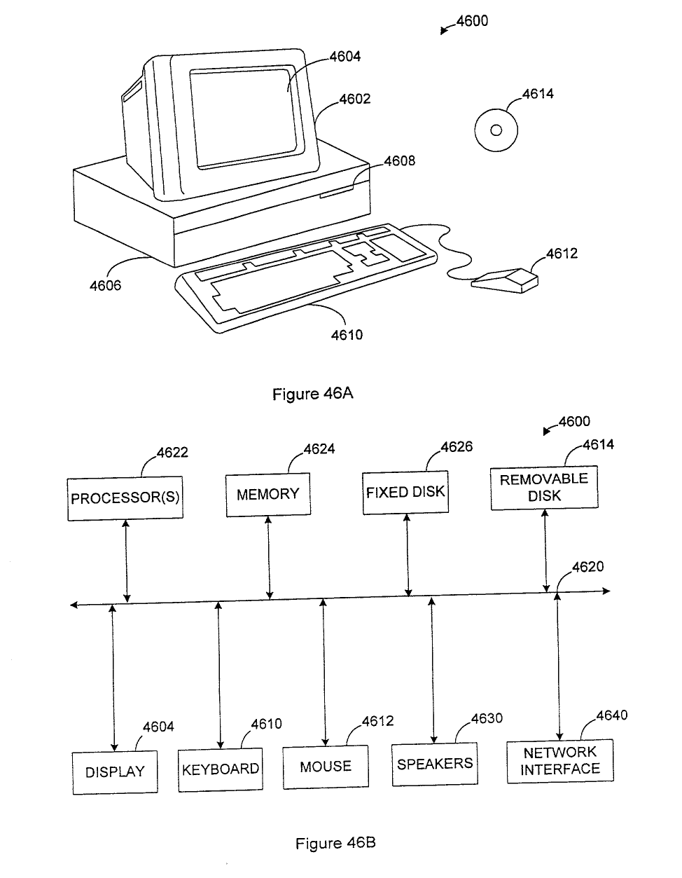

FIGS. 46A and 46B illustrate a computer system 4600 suitable for implementing embodiments of the present invention. A website or webpage can be hosted on computers and servers generally conforming to the description below. Users will also use similar computers to access such websites and webpages.

FIG. 46A shows one possible physical form of the computer system. Of course, the computer system may have many physical forms ranging from an integrated circuit, a printed circuit board and a small handheld device up to a huge super computer. Computer system 4600 includes a monitor 4602, a display 4604, a housing 4606, a disk drive 4608, a keyboard 4610 and a mouse 4612. Disk 4614 is a computer-readable medium used to transfer data to and from computer system 4600.

FIG. 46B is an example of a block diagram for computer system 4600. Attached to system bus 4620 are a wide variety of subsystems. Processor(s) 4622 (also referred to as central processing units, or CPUs) are coupled to storage devices including memory 4624. Memory 4624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 4626 is also coupled bi-directionally to CPU 4622; it provides additional data storage capacity and may also include any of the computer-readable media described below. Fixed disk 4626 may be used to store programs, data and the like and is typically a secondary storage medium (such as a hard disk) that is slower than primary storage. It will be appreciated that the information retained within fixed disk 4626, may, in appropriate cases, be incorporated in standard fashion as virtual memory in memory 4624. Removable disk 4614 may take the form of any of the computer-readable media described below.

CPU 4622 is also coupled to a variety of input/output devices such as display 4604, keyboard 4610, mouse 4612 and speakers 4630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 4622 optionally may be coupled to another computer or telecommunications network using network interface 4640. With such a network interface, it is contemplated that the CPU might receive information from the network, or might output information to the network in the course of performing the above-described method steps. Furthermore, method embodiments of the present invention may execute solely upon CPU 4622 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

What is claimed is:

1. A web site structure for organizing and providing information related to at least one first team registered with the web site, at least one member of said at least one first team registered with said web site, and at least one second team registered with said website, the web site structure comprising:
(a) a personalized home page created for said at least one registered team user and operative to impart schedules and information pertaining to said at least one first team and at least one second team registered with said web site;
(b) a personalized home page that is created for said at least one first team and operative to impart information and schedules regarding said at least one first team;
(c) a personalized home page dedicated to said at least one second team and operative to provide scheduling information related to said at least one second team; and
(d) wherein said at least one registered team member is provided access to said home pages of said first and second teams and selectively controllable access to said home page of said member.

2. The web site structure of claim 1 wherein said personalized home page of said at least one member comprises a first community area; and said personalized home pages of said at least one first team and said at least one second team comprise a second community area.

3. The web site structure of claim 1 further comprising a home page dedicated to a league registered with said web site within which said at least one first team and said at least one second team are participants.

4. The web site structure of claim 3 wherein said home page for said league comprises a third community area.

5. The web site structure of claim 2 wherein said first community area comprises a plurality of personalized home pages created for dedicated ones of said registered members of said at least one first team and access to each respective one of said personalized home pages as selectively controlled by each respective registered team member of said at least one first team.

6. The web site structure of claim 5 wherein access to a personalized home page of a registered member by an entity other than said registered member is provided by an invitation extended to said entity by said registered member.

7. The web site structure of claim 6 wherein the registered members of said first community area can send out invitations to other registered members to view their personal home pages in said first community area.

8. The web site structure of claim 7 wherein each respective one of said invitations carries a reciprocal invitation for the member sending said invitation to be able to view the personal information of the registered member receiving said invitation.

9. The web site structure of claim 6 wherein the registered member can invite a non-member not belonging to said at least one first team or said at least one second team to become a registered member of said web site.

10. The web site structure of claim 3 further comprising a central administrator having access to said first community area, said second community area and said third community area.

11. The web site structure of claim 6 further comprising a central administrator, said central administrator having selective control to resend an invitation or membership.

12. The web site structure of claim 10 wherein said central administrator can assign access capability to community areas for a registered member.

13. The web site structure of claim 1 wherein said at least one registered user is a child and said at least one first team and said at least one second team comprise youth sports teams.
